(19) United States
(12) Patent Application Publication
(10) Pub. No.: US 2021/0163776 A1
(43) Pub. Date: Jun. 3, 2021

(54) COATING COMPOSITIONS, PROCESSES, AND APPLICATIONS FOR LOW FRICTION AND HIGH DURABILITY SUBSTRATES

(71) Applicant: SURFTEC, LLC, Fayetteville, AR (US)

(72) Inventors: Samuel George Beckford, Fayetteville, AR (US); Cameron Crane, Fayetteville, AR (US); Randy Espinal Cabrera, Fayetteville, AR (US); German Perez, Fayetteville, AR (US); Seyed Mohammad Reza Razavi, Fayetteville, AR (US); Giselle Toledo, Fayetteville, AR (US)

(73) Assignee: SURFTEC, LLC, Fayetteville, AR (US)

(21) Appl. No.: 17/110,225

(22) Filed: Dec. 2, 2020

Related U.S. Application Data
(63) Continuation of application No. PCT/US2019/193526, filed on Jun. 3, 2019.
(60) Provisional application No. 62/749,028, filed on Oct. 22, 2018.
(60) Provisional application No. 62/749,036, filed on Oct. 22, 2018.
(60) Provisional application No. 62/749,049, filed on Oct. 22, 2018.
(60) Provisional application No. 62/679,884, filed on Jun. 3, 2018.

(51) Int. Cl. C09D 127/18; B32B 27/32; B32B 15/085; B32B 15/18; B32B 37/10

(52) U.S. Cl. CPC C09D 127/18; B32B 27/322; B32B 15/085; B32B 15/18; B32B 2311/30; B32B 2255/10; B32B 2255/26; B32B 2327/18; B32B 37/10

(57) ABSTRACT

The present invention relates to a coating composition comprising a fluoropolymer and a dopamine derivative. Further, the present invention relates to a process for coating a substrate, comprising the steps of (a) providing a coating composition comprising a fluoropolymer, a dopamine derivative and a solvent; (b) locating the coating composition on a substrate; (c) heating the coated substrate to remove the solvent; and (d) optionally pressing the heated coated substrate against another material surface to bond these to each other. The present coating composition allows the bonding of fluoropolymers through a process that eliminates the need for mechanical keying and hazardous or costly etching processes.

### CROSS-REFERENCE TO RELATED APPLICATIONS

This application is a continuation of PCT/US2019/035267 filed Jun. 3, 2019 and This application claims the benefit of U.S. Application Ser. No. 62/679,884 filed Jun. 3, 2018; U.S. Application Ser. No. 62/749,028 filed Oct. 22, 2018; U.S. Application Ser. No. 62/749,036 filed Oct. 22, 2018; and U.S. Application Ser. No. 62/749,049 filed Oct. 22, 2018.

### ACKNOWLEDGEMENT OF GOVERNMENT SUPPORT

This invention was made with Government support under SBIR contract No. 1738528, awarded by the National Science Foundation. The government has certain rights in the invention.

### FIELD OF INVENTION

The present invention relates to a coating composition comprising a fluoropolymer and a dopamine derivative, a process for coating a substrate, and an article coated with the coating composition.

### BACKGROUND OF THE INVENTION

Polytetrafluoroethylene (PTFE) is a highly inert polymer that can be difficult to bond to other materials. To enable bonding of PTFE coatings, binders such as polyimide are typically used in combination with PTFE and PTFE copolymers. To bond to bulk fluoropolymers products, the surface of the fluoropolymer is typically etched to de-fluorinate the polymer surface. Another way of attaching fluoropolymers to another material surface, is to create a porous surface on the opposing material to allow the fluoropolymer to be diffused into these pores. The latter is typically achieved by depositing metal particles on the opposing surface or utilizing a meshed structure that will allow the fluoropolymer to diffuse through and create a matrix of the fluoropolymer and porous surface.

The combination of polyimide and PTFE copolymers with PTFE creates a more wear resistant surface, but significantly increase the coefficient of friction and surface energy of PTFE. Further, etching processes can be very costly or involve the use of hazardous etchants that are problematic to store, use and dispose of. Mechanical keying processes create a matrix that has the combined properties of the fluoropolymer and porous surface. This combination of materials in the matrix will then affect the coefficient of friction, resistance to corrosion, wetting properties, and non-stick properties of the fluoropolymer.

Poor adhesion and wear resistance have mainly been resolved in the cookware industry with polyimide/polyamide. The use of polyimide/polyamide and a blend of fluoropolymer copolymer coatings, has created non-stick surfaces with sufficient bonding to prevent removal of the coating when used with low hardness cooking utensils. However, the scratch resistance and overall durability can be improved.

For example, U.S. Pat. No. 4,049,863 discloses a method for applying a PTFE (polytetrafluoroethylene) coating to cookware through the use of polyimide and PTFE copolymers. However, there is still a need for improved low friction and high durability coatings.

The present invention provides a coating composition comprising a dopamine derivative and a fluoropolymer that exhibits strong adhesion to fluoropolymer surfaces. Depositing the coating on a fluoropolymer surface allows subsequent bonding of that surface to various metal, non-metal, polymer, and ceramic surfaces.

Further, the coating composition of the present invention allows the bonding of fluoropolymers through a process that eliminates the need for mechanical keying and hazardous or costly etching processes. The coating composition of the present invention exhibits low friction, hydophobocity, icephobicity, and anticorrosive, properties. In addition, a comparable and improved adhesion strength is achieved without negatively affecting the desirable properties of fluoropolymers, as is the case with most mechanical keying and etching processes.

Another attribute of the present coating composition allows for extruded and skived fluoropolymer films with excellent cohesive strength to be bonded directly onto various substrates. This results in high strength laminated fluoropolymer films that can be used on non-stick, low-friction, or water repellant surfaces. As a result, the scratch resistance and overall durability of the laminated film is significantly higher when compared to the coating processes used in the cookware industry. Furthermore, the present coating composition can be used with various fluoropolymer products of different geometries that are currently only bonded by utilizing a hazardous etching process to break fluorine bonds at the surface of the fluoropolymer component.

Another attribute of the present invention provides the ability to modify the surface of a fluoropolymer to allow it to be directly bonded to various other materials. The adhesion of fluoropolymer components to various rubbers, for example, has significant industrial applicability. These compositions can be used in various seals, gaskets, and diaphragm pumps.

One of the key pain points expressed by the aerospace and aircraft industry is corrosion in large accessory drive gearboxes, housings, auxiliary power units, mounted accessory drives, power take-off shafts, fuel control/emergency power units, jet fuel starters, hydraulic starter motors, central gearboxes, and electric power transmissions. Consequently, another attribute of the present invention is that the highly durable, protective coating technology withstands extreme environmental wear and resists corrosion while continuously maintaining anti-corrosion as well as anti-icing/ice-phobic physical attributes.

Further, another attribute of the present invention is that substrates coated with the present composition can avoid aircraft detection by RADAR because the present compositions reduce reflection of RADAR spectrum.

### SUMMARY OF THE INVENTION

An embodiment of the present invention provides a coating composition comprising a fluoropolymer and a dopamine derivative.

An embodiment of the present invention provides a process for fabricating a coated a substrate, the process comprising the steps of:
(a) providing a mixed coating composition comprising a fluoropolymer, a dopamine derivative and a solvent;
(b) locating the coating composition onto a substrate; and
(c) heating and curing the coating composition to remove the solvent.

An embodiment of the present invention provides the process, wherein the fluoropolymer to the dopamine derivative in the composition has a weight ratio of from 1.0 to 50.

An embodiment of the present invention provides the process, wherein the fluoropolymer to dopamine derivative in the composition has a weight ratio of from 5.0 to 40.0.

An embodiment of the present invention provides the process, wherein the fluoropolymer to dopamine derivative in the composition has a weight ratio of from 6.0 to 30.0.

An embodiment of the present invention provides the process, wherein the fluoropolymer to dopamine derivative in the composition has a weight ratio of from 7.0 to 20.0.

An embodiment of the present invention provides the process, wherein the solvent is an aqueous liquid.

An embodiment of the present invention provides the process, wherein the solvent is water.

An embodiment of the present invention provides the process, wherein the solvent is isopropanol, ethanol, or methanol.

An embodiment of the present invention provides the process, wherein the solvent is combined with one or more components selected from the group consisting of n-butyl acetate, n-heptane, ethylene glycol monoethyl ether, ethyl acetate, and methyl ethyl ketone.

An embodiment of the present invention provides the process, wherein the coating composition further comprises a filler.

An embodiment of the present invention provides the process, wherein the coating composition further comprises a nanoparticle filler.

An embodiment of the present invention provides the process, wherein the filler is selected from one or more members of the group consisting of alumina, graphite, silica, quartz, sepiolite, capstone, and copper nanoparticles.

An embodiment of the present invention provides the process, wherein the coating composition further comprises a surfactant.

An embodiment of the present invention provides the process, wherein the dopamine derivative has a concentration of between 1.0 weight % to 20.0 weight %.

An embodiment of the present invention provides the process, wherein the dopamine derivative has a concentration of between 2.0 weight % to 8.0 weight %.

An embodiment of the present invention provides the process, wherein the fluoropolymer in the coating composition has a concentration of between 5.0 weight % to 60.0 weight %.

An embodiment of the present invention provides the process, wherein the fluoropolymer in the coating composition has a concentration of between 10.0 weight % to 60.0 weight %.

An embodiment of the present invention provides the process, wherein locating the coating composition further comprises dipping, spraying, spinning, or roll coating, or any combination thereof.

An embodiment of the present invention provides the process, wherein heating is at a temperature of between 250° C. to 400° C.

An embodiment of the present invention provides the process, wherein the process further comprises pressing the heated and coated substrate surface against another material surface to provide a lamination.

An embodiment of the present invention provides the process, wherein the coated substrate is anti-corrosive.

An embodiment of the present invention provides the process, wherein the coated substrate is anti-radar.

An embodiment of the present invention provides the process, wherein the coated substrate is ice-phobic.

An embodiment of the present invention provides a coating composition comprising a fluoropolymer, a dopamine derivative, and copper nanoparticles.

An embodiment of the present invention provides a coating composition comprising a fluoropolymer, a dopamine derivative, and graphite nanoparticles.

An embodiment of the present invention provides a coating composition comprising a fluoropolymer, a dopamine derivative, and silica nanoparticles.

An embodiment of the present invention provides a coating composition comprising: a fluoropolymer, a dopamine derivative, and alumina nanoparticles.

An embodiment of the present invention provides an ice-phobic coating composition prepared by a process comprising the steps of:
mixing a fluoropolymer, a dopamine derivative, a solvent and filler.

An embodiment of the present invention provides, the process, wherein the filler is one or more nanoparticle components selected from the group consisting of alumina, graphite, silica, quartz, sepiolite, capstone, and copper.

An embodiment of the present invention provides, an anti-radar coating composition prepared by a process comprising the steps of:
mixing a fluoropolymer, a dopamine derivative, a solvent and filler.

An embodiment of the present invention provides, the process, wherein the filler is one or more nanoparticle components selected from the group consisting of alumina, graphite, silica, quartz, sepiolite, capstone, and copper.

An embodiment of the present invention provides, an anti-corrosive coating composition prepared by a process comprising the steps of:
mixing a fluoropolymer, a dopamine derivative, a solvent and filler.

An embodiment of the present invention provides, the process, wherein the filler is one or more nanoparticle components selected from the group consisting of alumina, graphite, silica, quartz, sepiolite, capstone, and copper.

An embodiment of the present invention provides a coated composition characterized by the XPS pattern shown in FIG. 47.

An embodiment of the present invention provides a coated composition characterized by the XPS pattern shown in FIG. 48.

An embodiment of the present invention, further comprising pressing to densify and reduce porosity before, after, or during heating and curing the coating composition to remove the solvent.

### BRIEF DESCRIPTION OF THE FIGURES

FIG. 1a is a picture of a peel test equipment used to determine the adhesion strength of laminated samples.

FIG. 1b is a picture of a peel testing process of laminated PTFE composite films 1″×2″ 1006 carbon steel substrate samples (laminated sample before testing).

FIG. 1c is a picture of a peel testing process of laminated PTFE composite films 1″×2″ 1006 carbon steel substrate samples (laminated sample during testing).

FIG. 1d is a picture of 90° bending of laminated samples (laminated sample before bending).

FIG. 1e is a picture of 90° bending of laminated samples (laminated sample after bending).

FIG. 2 is a graph of a typical 90° peel test raw data and processing.

FIG. 3 is a raw graph obtained from 90° peel test using the MTESTQUATTRO.

FIG. 4 is a graph of data from FIG. 3 processed using ORIGINPRO 2018. N=n=number of data points, from the curve, used to calculate the mean, standard deviation (SD), maximum, and minimum values.

FIG. 5 is a graph of comparison of peel test results for the first set. Five different concentrations of PDA were tested (8, 4, 3, 2, and 0% (w/w)). Each bar represents the average±standard deviation of three samples, n=3, unless otherwise indicated.

FIG. 6 is a graph of comparison of peel test results for the second set. Five different concentrations of PTFE were tested (40, 20, 14, 10, and 0% (w/w) or control). Each bar represents the average±standard deviation of three samples, n=3, unless otherwise indicated.

FIG. 7 is a graph of coating thickness for the different amounts of coating composition sprayed on the PTFE composite film.

FIG. 8 is a graph of surface profile illustrating the thickness of the spray coated material (right) relative to the surface of uncoated PTFE composite film liners (left) corresponding to a coating of 0.006 g/in² on the surface.

FIG. 9 is a graph of surface profile illustrating the thickness of the spray coated material (right) relative to the surface of uncoated PTFE composite film liners (left) corresponding to a coating of 0.06 g/in² on the surface.

FIG. 10 is a graph of surface profile illustrating the thickness of the spray coated material (right) relative to the surface of uncoated PTFE composite film liners (left) corresponding to a coating of 0.02 g/in² on the surface.

FIG. 11 is a graph of peel test results of laminated samples coated at different thicknesses. Each bar represents the average±standard deviation for n=3.

FIG. 12 is a graph of peel test results of laminated samples made using different curing temperatures. Each bar represents the average±standard deviation for n=3.

FIG. 13 is a graph of peel test results of the lamination time experiment. Each bar indicates the average±standard deviation for a set of three samples (n=3).

FIG. 14 is a graph of peel test results of samples laminated under 1,000, 2,000, and 3,000 pounds of force. Each bar shows the average±standard deviation for n=3.

FIG. 15 is a depiction of Salt Spray results (0.1 M NaCl at 35 C) illustrating difference in corrosion for coated and uncoated substrates.

FIG. 16 is a graph of Tribo-corrosion results (0.1 M NaCl at 25 C) demonstrating corrosion with regards to wear for coated and uncoated steel substrates.

FIG. 17 represents contact angle measurements with respect to time illustrating the effect of immersion in acidic and basic conditions have on the coated substrates.

FIG. 18 is a schematic of the anti-radar mechanism.

FIG. 19 is a 2D and 3D image of coated aluminum substrates.

FIG. 20 is the 3D laser Microscope Surface Profile.

FIG. 21 is an image of system arrangement for bistatic measurements.

FIG. 22 is an image of the coated anti-radar sample.

FIG. 23 depicts images of four samples of uncoated embossed aluminum sheets.

FIG. 24 depicts images of four samples of coated embossed aluminum sheets.

FIG. 25 depicts glaze ice on uncoated sample sheets after 5 days.

FIG. 26 depicts coated sample sheets after 5 days.

FIG. 27 depicts uncoated sample sheets after 9 days.

FIG. 28 depicts Cassie-Baxter ice on coated sample after 9 days.

depicts ice formation on coated beams before and after centrifuge.

FIG. 29 depicts coated samples with spherical shaped ice formed on the surface after 14 days.

FIG. 30 depicts uncoated sample sheets had flat glaze ice form on the surface at 14 days.

FIG. 31 depicts the ice formation on coated beams before and after centrifuge ice adhesion test.

FIG. 32 depicts the effect of withdraw speed on film thickness.

FIG. 33 depicts the effect of withdraw angle on film thickness.

FIG. 34 depicts the film thickness of multilayer dip coatings.

FIG. 35 depicts the effect of withdraw speed on top to bottom film thickness uniformity in large and curved substrates.

FIG. 36 depicts multilayer PTFE dip coating illustrating the coating's thickness and roughness relative to mirror polished stainless-steel substrate.

FIG. 37 depicts PTFE ‘dry’ spray coating illustrating the coating's thickness and roughness relative to mirror polished stainless-steel substrate.

FIG. 38 depicts PTFE ‘wet’ spray coating illustrating the coating's thickness and roughness relative to mirror polished stainless-steel substrate.

FIG. 39 depicts different spray coated fluorocarbon composite materials.

FIG. 40 depicts Spray coated PTFE and PDA/PTFE/Graphite coatings on curved substrates.

FIG. 41 depicts a graph of surface roughness of PTFE dip and spray coatings on stainless steel substrates.

FIG. 42 depicts durability of ‘dry’ sprayed virgin PTFE and PDA sub coat+PTFE top coat on stainless steel substrates

FIG. 43 depicts durability of ‘wet’ sprayed virgin PTFE and PDA sub coat+PTFE top coat on stainless steel substrates

FIG. 44 depicts coefficients of friction for different spray coated fluorocarbon composite materials

FIG. 45 depicts a graph of the durability of composite PDA/PTFE/Graphite coatings on stainless steel substrates

FIG. 46 depicts a graph of the durability of PTFE and PDA/PTFE/Graphite coating on stainless steel substrates

FIG. 47A-47D depicts high-resolution XPS spectra of a) PDA dip coating tris.HCl method b) dip coating PDA formed with oxidizer c) spray coating without curing d) spray coating with curing at 315° C.

FIG. 48A-47D depicts nitrogen high-resolution XPS spectra of a) PDA dip coating tris.HCl method b) dip coating fast PDA c) spray coating without curing d) spray coating curing at 315° C.

### DETAILED DESCRIPTION OF THE INVENTION

In the following detailed description, reference is made to the accompanying drawings that form a part hereof, and which are shown, by way of illustration, in several embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly recites otherwise. As used in this specification and the appended claims the term “or” is generally employed in its sense including “and/or” unless the content clearly recites otherwise.

As used herein, “have,” “having,” “include,” “including,” “comprise,” “comprising” or the like are used in their open-ended sense, and generally mean “including, but not limited to.” It will be understood that the terms “consisting of” and “consisting essentially of” are subsumed in the term “comprising,” and the like.

As used herein, “aqueous” and “aqueous liquid” is understood to mean a solution in which the solvent is water. As used herein, the word “aqueous” is defined as pertaining to, related to, similar to, or dissolved in water.

As used herein, the term “filler” is understood to mean nanoparticles, added to a composition which can improve specific properties of the overall composition. As relates to the present invention, a “filler” will be in a quantity or concentration less than PDA or PFTE.

As used herein, the term “surfactant” is understood to mean compounds that lower the surface tension (or interfacial tension) between two liquids, between a gas and a liquid, or between a liquid and a solid. Surfactants may act as detergents, wetting agents, emulsifiers, foaming agents, and dispersants.

As used herein, the term “solvent” is understood to mean the component of a solution that is present in the greatest amount. It is the substance in which the solute is dissolved.

As used herein, the term to “mix” or “mixture” is understood to mean a material made up of two or more different substances which are physically combined.

As used herein, the term “locating a coating composition” is understood to mean coating a substrate by dipping, spraying, spinning, or rolling coating, or any combination thereof.

As used herein, the term “substrate” is understood to mean the medium in which a chemical reaction takes place or the reagent in a reaction that provides a surface for absorption. As used herein, a “substrate” is a base on which a process occurs.

As used herein, the term “anti-corrosion” is understood to mean the protection of metal surfaces from corroding in high-risk (corrosive) environments such as where high humidity, mist, and salt are factors.

As used herein, the term “ice-phobic” or “anti-ice” is understood to mean properties of a substance that can de-ice, delay the reformation of ice for a certain period of time, or prevent adhesion of ice to make mechanical removal easier.

As used herein, the term “anti-radar” is understood to mean applications, components, or compositions used to prevent or minimize RADAR (Radio Detection and Ranging) or LI DAR detection. RADAR is a detection system that uses radio waves to determine and map the location, direction, and/or speed of both moving and fixed objects such as aircraft, ships, motor vehicles, weather formations and terrain. LIDAR is Light Detection and Ranging. A lidar system uses laser pulses to measure atmospheric constituents such as aerosol particles, ice crystals, water vapor, or trace gases (e.g. ozone). A lidar transmits short pulses of laser light into the atmosphere to reveal the corresponding distance between the atmospheric scatter and the lidar.

Coating Compositions

One embodiment of the present invention relates to a coating composition comprising a fluoropolymer and a dopamine derivative.

The term “fluoropolymer” as used herein refers to any polymer including the fluoro group. In one embodiment, the fluoropolymer may be PTFE (polytetrafluoroethylene). The term “PTFE” as used herein, refers to polytetrafluoroethylene and all its derivatives, composites, and copolymers in which polytetrafluoroethylene is the main component.

The term “dopamine derivative” as used herein refers to any catecheolamine-based substance rich in 3,4-dihydroxy-L-phenylalanine (DOPA) that will form macromolecules or polymerize upon oxidation. The term “dopamine derivative” as used herein may also refer to any dopamine based substance which can be polymerized to produce PDA.

The term PDA (polydopamine) as used herein may refer to noncovalent agregates of catecholamine-based substances and polymerized catecholamine-based substances. The term “PDA” as used herein may also refer to polydopamine, noncovalent aggregates of dopamine and 5,6-dihydroxyindole, and any polydopamine composite in which polydopamine is the main component.

In one embodiment of the present invention, the dopamine derivative can include a dopamine monomer, or a combination of the dopamine monomer and polydopamine. This is because, when the dopamine derivative is mixed with PTFE, the dopamine derivative can begin to form macro molecules such as some degree of polymerization.

In one embodiment, the dopamine derivative may include, but is not limited to, one or more derivatives selected from the group consisting of dopamine hydrochloride, norepinephrine, epinephrine, isoproterenol, unpolymerized dopamine, L-3,4-dihydroxyphenylalanine, and melanin.

In one embodiment, the ratio by weight the fluoropolymer to the dopamine derivative in the coating composition can be controlled depending on the desired physical properties such as friction and durability. In one embodiment, the ratio by weight the fluoropolymer to the dopamine derivative may range from 1.0 to 50.0, preferably 5.0 to 40.0, preferably 6.0 to 30.0, or preferably 7.0 to 20.0.

In one embodiment of the present invention, the coating composition comprises a solvent. The solvent may include, but is not limited to, an aqueous liquid. In another embodiment, the solvent is water. In yet another embodiment, the solvent is isopropanol, ethanol, or methanol. In yet another embodiment, solvents may be combined with additional components in small concentrations, such as for example, n-butyl acetate, n-heptane, ethylene glycol monoethyl ether, ethyl acetate, and methyl ethyl ketone to give a particular characteristic, like fast-drying.

In another embodiment, the coating composition may further comprise fillers to improve adhesion to specific substrates. In some embodiments, the filler comprises one or more of alumina, graphite, silica, quartz, sepiolite, capstone, or copper nanoparticles.

The addition of nanoparticle fillers to polymers leads to an enhancement of the material's mechanical and physical properties. The key to this phenomenon is the miscibility of the nanoparticles within a polymeric matrix. The hydrophilic filler particles disperse better in a hydrophilic polymer than in a hydrophobic polymer. Copper nanoparticles, for example, are widely used in different research applications. Fluoropolymers have appealing properties such as low surface energy and hydrophobicity. However, because fluoropolymers are susceptible to creep, deformation, and wear, the incorporation of nanoparticle fillers, inter alia, can increase the modulus of elasticity and hardness of a polymer matrix. In order to evenly disperse nanoparticles in a fluoropolymer matrix the surface of the nanoparticles must be modified. One method of modification is through the oxidation of dopamine hydrochloride in a basic solution to yield a PDA coating of a certain thickness. The resulting PDA coating can then be used to modify the surface of nanoparticles fillers to promote chemical or physical bonding within the polymer chains. Moreover, surface modification using PDA produces less agglomeration of nanoparticles and allows for more even dispersal in the fluoropolymer matrix.

In another embodiment, the coating composition may further comprise various surfactants. The various suitable surfactants are well known to one of reasonable skill in the relevant art.

Process for Coating a Substrate

One embodiment of the present invention relates to a process for coating a substrate, comprising the steps of (a) providing a coating composition comprising a fluoropolymer, a dopamine derivative and a solvent; (b) locating the coating composition on a substrate; (c) heating the coated substrate to remove the solvent; and optionally (d) pressing the heated coated substrate against another material surface to bond these to each other.

The substrate may vary depending on the desired target. In some embodiments, the substrate may comprise a metal, a polymer, or ceramic.

In another embodiment, the substrate may be bearings.

Step (a): Providing a Coating Composition Comprising a Fluoropolymer, a Dopamine Derivative and a Solvent

The step (a) comprises providing a coating composition comprising a fluoropolymer, a dopamine derivative and a solvent.

As described above, the ratio by weight of the fluoropolymer to the dopamine derivative in the coating composition can vary depending on the desired physical properties.

In one embodiment, the dopamine derivative solution and the fluoropolymer solution can be mixed with each other to make the coating composition. The concentration of the dopamine derivative and the fluoropolymer may vary depending on the ratio by weight of the fluoropolymer to the dopamine derivative. In one embodiment, the concentration of the dopamine derivative in the dopamine derivative solution may range from 1.0 to 20.0 weight %, preferably 1.0 to 15.0 weight %, preferably 1.0 to 10.0 weight %, or preferably 2.0 to 8.0 weight %. In another embodiment, the concentration of the fluoropolymer in the fluoropolymer solution may range from 5.0 to 60.0 weight %, preferably from 5.0 to 50.0 weight %, or preferably from 10.0 to 60.0 weight %.

Step (b): Locating the Coating Composition on a Substrate

The step (b) comprises locating the coating composition on a substrate. The method of locating the coating composition on the substrate may vary depending on the desired properties or various shapes of the target for coating. In one embodiment, the coating method may include, but not be limited to, a dip coating, spray coating, spin coating, or roll coating process, or any combination thereof. In another embodiment, the coating method may include the spray coating.

Depending on the desired properties of the coating, the thickness of the coating may vary. In one embodiment, the thickness of the coating may range from 1 μm to 300 μm; preferably 1 μm to 120 μm; preferably 1 μm to 100 μm; preferably 3 μm to 40 μm; or preferably 4 μm to 6 μm.

Step (c): Heating and Curing the Coated Substrate to Remove the Solvent

The step (c) comprises heating the coated substrate to remove the solvent. When the coated composition is heated, the dopamine derivative is polymerized to produce PDA (polydopamine). In some embodiments, the dopamine derivative can be polymerized and carbonized to a certain extent. This may produce the final bonding to the substrate. In another embodiment, when the coated substrate is heated, polymer particles of the fluoropolymer and PDA are sintered.

In some embodiments, the coated substrate is heated at a temperature of 250° C. to 400° C.; preferably 250° C. to 350° C.; preferably 280° C. to 340° C.; preferably 300° C. to 330° C.; or preferably 310° C. to 320° C.

Further, in some embodiments, the coated substrate may be heated for 20 seconds to 11 min; preferably 3 min to 20 min; preferably 5 min to 15 min; or preferably 9 min to 11 min.

Optional Step (d): Pressing (Laminating) the Heated Coated Substrate Against Another Material Surface to Bond these to Each Other

The optional step (d) comprises pressing the heated coated substrate against another material surface to bond these to each other.

Depending on the desired physical properties, the pressure, time and temperature at the step (d) can vary. In one embodiment, the pressing may be carried out under a pressure of 100 to 1,700 lb/in²; preferably 500 to 1,500 lb/in²; preferably 800 to 1,200 lb/in²; and preferably 950 to 1,050 lb/in² depending on the desired physical properties. In one embodiment, the pressing may be carried out for 3 min to 20 min; preferably 5 min to 15 min; or preferably 9 min to 11 min.

In one embodiment, the pressing may be carried out at a temperature of 300° C. to 400° C.; preferably 330° C. to 390° C.; preferably 350° C. to 380° C.; or preferably 360° C. to 380° C.

### EXAMPLES

Preparation of Composition Examples

Dip Coating Examples

The present invention has been successfully used in the deposition of PTFE films on larger 2″×4″ 316 stainless-steel substrates via dip coating. Dip coated PTFE samples demonstrate comparable performance all in terms of surface coverage, coating thickness, surface immobilization, and time of deposition as compared to smaller 1″×1″ substrates used in preliminary studies. The PTFE solution used was 60 w/w PTFE aqueous dispersion. The solution was used as-is to deposit the PTFE coatings. Diluting the solution further resulted in the formation of thinner films, while attempting to incorporate different solvents in order to aid with the drying time affected the dispersion of the PTFE particles in solution, yielding non-uniform films.

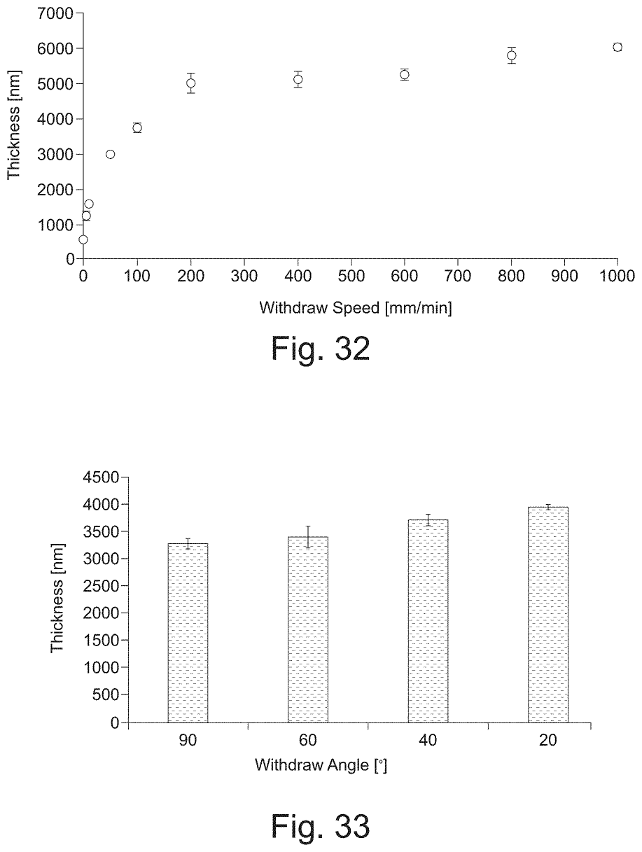

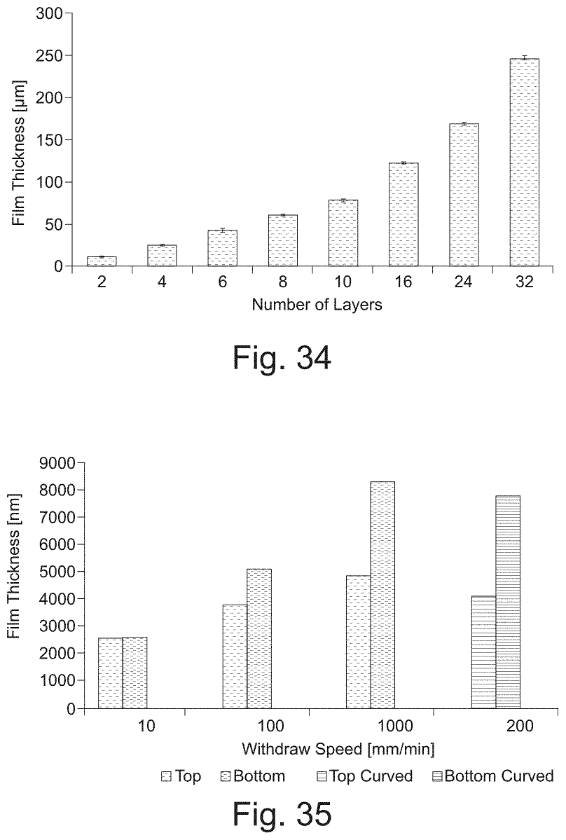

Dip coatings offer outstanding surface coverage upon scale-up. Trends in film properties with regards to withdraw speeds FIG. 32 and withdraw angles FIG. 33, as well as reproducibility in film thickness FIG. 34, upon multilayer coatings, all remain consistent with dip coatings of larger substrates. Maintaining an even coating thickness can however be a concern with larger substrates, regardless of geometries. This occurs due to liquid drag on the surface which can result in greater top to bottom variations at high withdraw speeds (>200 mm/min). This effect can however be minimized upon a more careful control of the depositions at lower withdraw speeds (<50 mm/min) FIG. 35.

In dip coatings, film thickness can be tailored upon increasing the withdraw speed at which a substrate is withdrawn from the solution. As FIG. 32 illustrates, while this trend rises sharply up to 200 mm/min, it then tends to flatten at higher withdraw speeds. At that stage, liquid drag on the surface also hinders the formation of thicker films, as excess film simply drags down the surface of the substrate. This can result in the formation of uneven coating which exhibit thicker film towards the bottom. Similarly, the withdraw angle at which a substrate is removed from the solution can be used to tailor the thickness of the film. The effect of withdraw angle on film thickness as FIG. 33 demonstrates is much smaller than that of withdraw speed. Additionally, while easy to demonstrate and utilize on flat substrates, it is much more complicated to employ in one's favor with more complex geometries.

While larger substrates will take longer to dip at similar withdraw speeds, the duration of the process is predominately determined by the desired film thickness, and thus depends more on the number of layers required in order to reach a certain thickness FIG. 34 than the size of the substrate. It is well known that in general, performance is proportional to the thickness of the coating. In essence, thicker coatings take longer to wear, and thus lead to an increase in performance. In addition, thicker coats allow for the formation of a transfer film on the counterface that in essence results as if the coating was sliding against itself, thus in such balance allowing for the formation of interface of outstanding low friction/low wear practical properties. To ensure reproducible results, the durability tests were repeated three times on different replicate samples for each coating condition, error bars in the data plots represent the standard deviation among replicates. Durability tests on the samples were performed using a rotary ball-on-disk configuration, with a 6.5 mm diameter chromium steel balls, 15 N load, 500 RPM sliding speed, and 4 mm stroke diameter on a Tribometer. It is important to note that tests performed on these surfaces are rather aggressive. We employ this high speed/high force tests to assess the surfaces wear life and coefficient of friction keeping in mind the demanding requirements of the bearings application for which these surfaces are being developed.

While the combination of withdraw speeds and solution properties can be utilized to control the dip coated film thickness, such films are limited to a maximum thickness. In addition, formation of this coatings requires drying, baking, and curing steps upon addition of each layer, requiring considerable time to achieve thick (multilayer) coatings. Although direct scale-up is rather seamless for dip coatings upon the acquisition of proper equipment, for application where the deposition of thicker films is desired, dip coatings are limited in terms of production efficiency as they require the deposition of multiple layers that in turn require time consuming drying and curing steps upon addition of each layer.

Spray Coating

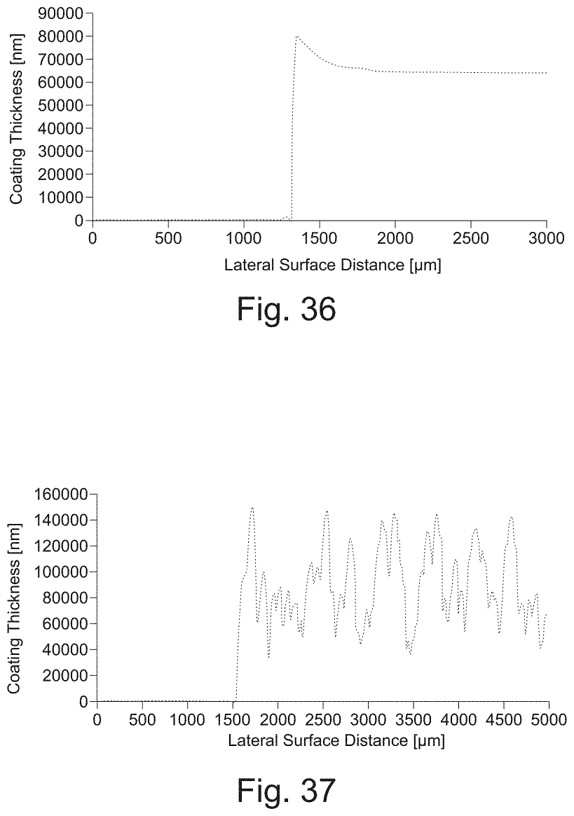

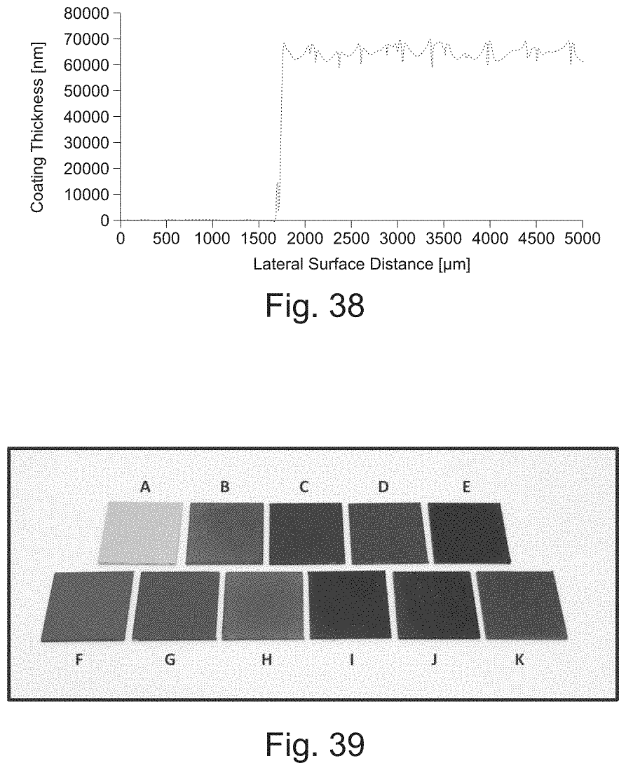

Dip coating, spray coating and roll coating can be used to locate the coating of the present invention onto a substrate. Spray coatings offer the practical benefit of being more versatile, in particular when there exists the need of attaining thicker coatings. While traditional dip coating methods require multiple layers (fourteen or more) in order to reach thickness greater than 100 microns, consequently requiring hours (ten or more), spray coated substrates can reach single film of comparable thickness in minutes. A surface stylus profilometer was used to measure the surface roughness and coating thickness of the samples. Dip coatings yield dense films of outstanding uniformity FIG. 36. PTFE spray yields less dense, much more uneven coverages. More aerosolized (dry) sprays FIG. 37 further amplify such disparity. Less aerosolized ‘wet’ sprays FIG. 38 lessen such variations, however, are more prone to cracking upon drying. Spraying thick ‘wet’ films (over 50 microns) thus need greater care upon spraying and can require in some cases drying steps between sprays. Applying pressure and heat, aids in densifying the coating, reducing porosity, and reducing the surface roughness.

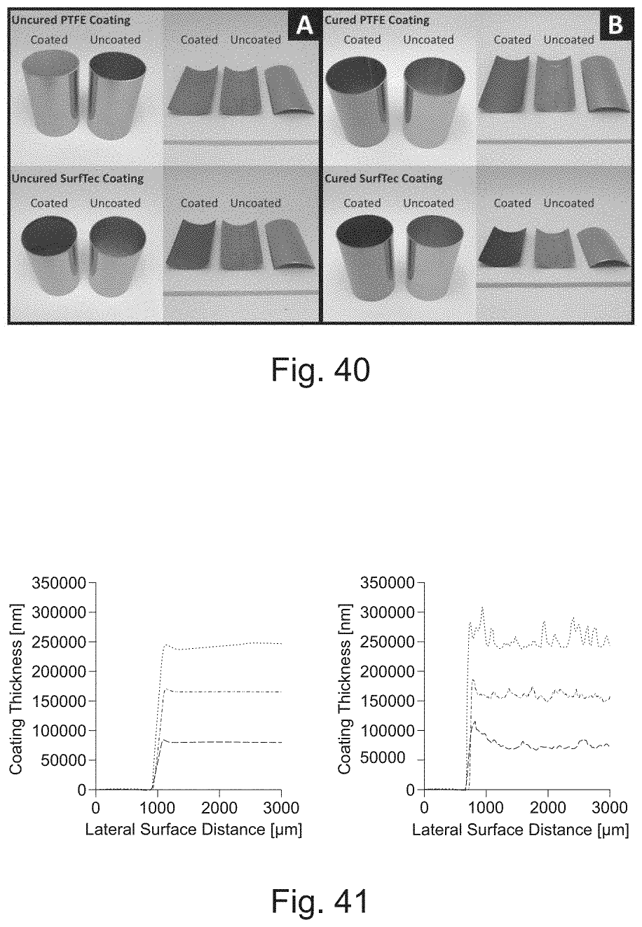

FIG. 39 shows the different PTFE based coatings successfully deposited onto stainless-steel substrates via spray coating. Various particle filler PDA/PTFE coatings have been developed to improve the load bearing capability of PTFE, thermal conductivity, transfer film formation, as well as reduce crack propagation and debris formation. Substrates having curved geometries FIG. 40 have also been coated using the present invention. PTFE exhibits a characteristic color change in appearance from white to clear as it cures past crystalline melting point of the resin particles. The PDA based coatings of the present invention exhibit its own unique color change as dopamine polymerizes upon exposure to similar curing temperatures. Such changes were clearly observed for both PTFE and the PDA/PTE/Graphite coating.

As compared to dip coating in which the average surface roughness of the coatings remains consistent as the coating thickness progresses upon addition of subsequent film layers, spray coating increases in roughness as the thickness of the coatings progress FIG. 41. This is a characteristic of the spray deposition method and the materials being sprayed. Spray coating atomizes the solution, and thus deposits drier coatings with PTFE particles arranged in agglomerates that produce a more porous surface compared to dip coating in which a thin wet film is added which allows the PTFE particles to arrange themselves in a more ordered fashion and produce denser and smoother coatings. Interestingly, the added surface roughness resulting from spray coating yields a final micro texture that enables spray coating to exhibit ultra-hydrophobic properties, much higher than those of the properties of the bulk material. These properties can be further tailored by the material and concentration of particle fillers used.

The addition of fillers, graphite for example, help in increasing surface uniformity. It is important to remember that these values are the average of peaks and valleys. While the presence of high peaks might result in the measurement of a much higher average thickness, it is often the thinner valleys that ultimately dictate tribological performance of the coatings. For this reason, attaining a higher degree of surface uniformity is crucial. Methods to densify spray coating post spray to even the surface topography using techniques which press the coatings upon curing at moderate and high, temperature and pressures have been developed. This treatment of the surfaces upon this technique has proven to be successful in increasing the wear life of the coating.

Tribological Comparison of Aerosol Coating to Dipped Coating

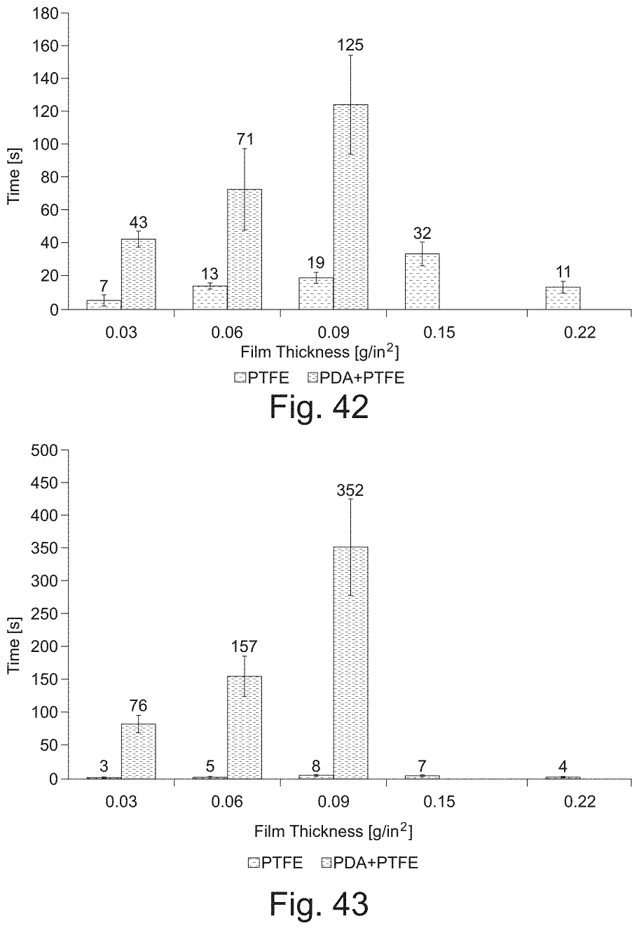

Adhering virgin PTFE onto substrates can be a challenge. Poor surface adhesion often results in poor tribological performance, so do imperfections such as cracks in the material. PTFE coatings can suffer from both. While the PTFE coatings exhibit strong polymer cohesion upon curing, they often demonstrate very poor adhesion to the surface. Spray and dip coated pure PTFE coatings exhibit the low coefficient of friction expected of PTFE, however wear at a rapid rate, regardless of the spraying or dipping condition. It is important to once again to note, that durability tests performed on these surfaces are by design aggressive (ball-on-flat tribological set up, 15 N Load, 500 RPM, 8 mm diameter ball counterface) in order to reduce testing duration. As FIG. 42 demonstrates, and data in FIG. 43 corroborates, pure PTFE coatings wear very rapidly under these testing conditions. Further, regardless of whether the coating was ‘wet’ sprayed or ‘dry’ sprayed, poor surface adhesion coupled with cracking of thicker films prevents the use of thicker coatings to extend the durability of the film. The failure mode for the PTFE coatings is delamination and tearing, rather than the slow abrasive wear that occurs for the surfaces first treated with the spray coated PDA layer or the composite PDA/PTFE material which adheres more strongly to the substrate. The increase in performance upon surface treatment with the spray coated PDA solution (0.002 g/in² in mass, ˜1 um thickness), observed for both ‘wet’ and ‘dry’ sprayed PTFE is quite remarkable. While the increase in performance is consistent with increasing coating thickness for both spray methods, the performance of the ‘wet’ coated PTFE coatings is superior than that of ‘dry’ coated PTFE upon addition of the PDA sub coat, a trend that was opposite prior to PDA surface treatment.

While this PDA based technology minimizes concerns in term of surface adhesion, different chemical treatments as well as grit blasting in order to roughen the surface are often used in industry to try to facilitate this attachment. Grit blasting increases surface roughness allowing for a greater contact area. This allows PTFE to penetrate such grooves and immobilize mechanically upon hardening. In order to mimic such roughening, substrates were sanded. The durability of pure PTFE coatings increased upon sanding. Results in combining PDA spray surface treatment along with sanding of the substrates did not reveal a considerable increase in performance. While an increase exists, in particular for ‘dry’ sprayed coatings which one would not expect would penetrate as deeply into the added substrate texture as ‘wet’ sprayed coating, the increase in performance is not stackable. While such surface treatments can complement each other, the benefits depend more on the type of application, the properties of the substrate to be utilized and the desired coating thickness.

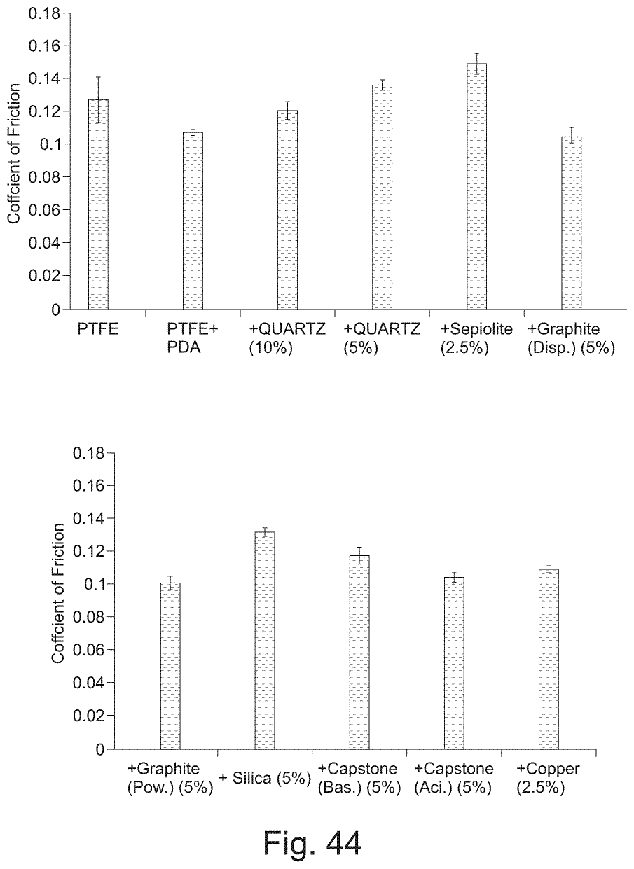

The presence of PDA in the PTFE composite material enables a normal wear progression of the coating as the coating is well adhered to the surface. For this reason, the effect of the PDA sub coat on PDA composite coatings is not as pronounced. In fact, while the effect is apparent at lower thickness, it is not as significant upon reaching thicker coatings. As with PTFE dip and spray coatings, PDA/PTFE composite materials demonstrate a similar trend with regards to durability as it relates to coating thickness. The incorporation of PDA as a bulk composite PTFE material also enables for the spraying of coatings of 500 microns without the adverse effects of cracking upon drying and curing that limit the formation of thicker pure PTFE spray coatings. As compared to pure PTFE coating, PDA/PTFE composite spray coatings not only offer lower coefficient of friction (0.107 for PDA/PTFE vs 0.128 for pure PTFE) FIG. 44, but they also outperformed the performance of PTFE coatings. As discussed previously, while thicker coatings will take longer to wear through, thicker coatings also enable for the formation of a transfer film on the counterface which allows for the formation of sliding interfaces of much lower wear rates.

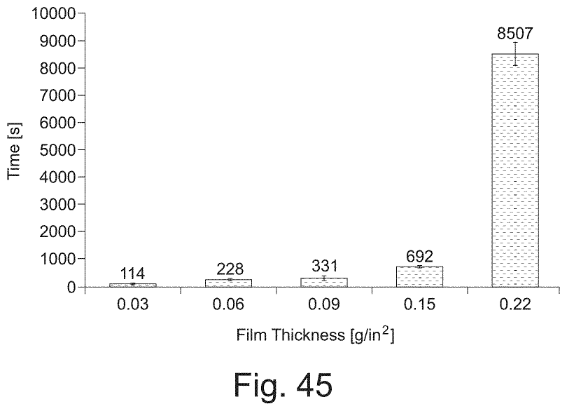

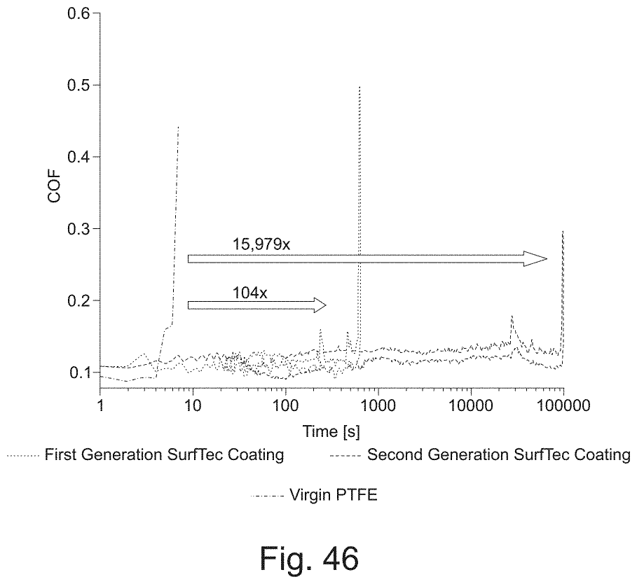

Composite materials not only change the mechanical properties of the material but can speed up and affect the formation of a more tenacious transfer film. While the addition of different fillers can adversely affect the tribological properties of the material, a filler that has great potential is graphite. Graphite may precisely ensure the formation of a tenacious transfer film. PDA/PTFE/Graphite composite coatings illustrate this trend. As FIG. 45 demonstrates, the addition of graphite increased the tribological performance of the coatings as compared to pure PTFE coatings as well as thick PDA/PTFE coatings. While as with other coatings PDA/PTFE/Graphite coatings can first wear more rapidly, these surfaces offer an outstanding combination of coefficients frictions and durability upon formation of transfer films, as demonstrated by its outstanding performance at higher thickness. The performance of a coating is dependent both on the adhesion to the surface as well as cohesion within the polymer. For this reason, it is not just the composition of the coating, but the treatment of the substrate, as well as post spraying treatments, such as the densification upon pressing for example, that dictate the final properties of the coating. PDA/PTFE/Graphite incorporates those improvements to yield a product of outstanding tribological performance. The PDA/PTFE/Graphite coating offers a 15978 fold increase in wear-life as compared to virgin PTFE spray coatings on stainless-steel substrates and a 154 fold increased in wear-life as compared PTFE coating with similar substrate and coating treatments (spray PDA coating on a sanded substrates and pressing at 300° C. at 1000 PSI for 5 minutes before final curing at 372° C.) FIG. 46.

The PDA/PTFE composite material of the present invention, offers an outstanding platform to assess different fillers for the creation of more specialized next generation surface coatings. The incorporation of different fillers can aid in the improvement of the coatings load carrying capacity, thermal conductivity, transfer film formation, as well as reduce crack propagation and debris formation.

Testing on the different fillers indicate that in terms of lowering the coefficients of friction the addition of graphite particles in PDA/PTFE exhibit the lowest coefficients of friction FIG. 44. It is important to note that the average coefficient of friction of both PDA/PTFE/Graphite coatings (0.102) is close to 20% lower than that of pure PTFE (0.128). While the base PDA/PTFE coating also performs strongly in terms of coefficients of friction, it suffers more than other in terms of durability. Two different graphite formulations were prepared in order to test whether purchasing of the graphite nanoparticles from vendors in it powder form or as a concentrated dispersion affected the overall properties of the material. While no considerable differences exist between the two, it is worth noting the dispersed graphite nanoparticles yielded surfaces with slightly higher surface energies as being less particulate they did not form as much of a micro texture as those that come as a solid powder. While addition of different fillers selected predominantly affected the performance of the coating in terms of coefficients of friction, the same fillers performed strongly in terms of increasing the wear like of the PDA/PTFE based coatings. Out of those fillers, the one that certainly stands out in terms of wear-life is the addition of quartz as a filler. As we have observed in the past, higher filler concentration does not necessarily correlate with durability. As compared to more concentrated formulations, the 5% PDA/PTFE/Quartz composition outperformed that of 10% by more than double. It is also important to note that this 5% PDA/PTFE/Quartz composition outperforms pure PTFE 670 times over. The addition of different fillers can similarly allow us to modify the composition of the composite material, as well as the interfacial properties. The addition of Sepiolite which can be further readily modified chemically, significantly increases the surface energy (hydrophilicity) of the coating. The addition of different filler materials offers differing opportunities to tune the interfacial properties of fluorocarbon coatings for the development of more robust next generation surface coatings.

Spray Coating, Curing, and Lamination

The examples were performed regarding the PTFE:PDA ratio, coating thickness, and curing temperature of the coating composition. Pressing parameters such as lamination duration and lamination force, were also tailored for PTFE composite films. Finally, a coating composed of PTFE, PDA and copper nanoparticles was deposited on PTFE composite films at a ratio of 2:1:1 and thickness of about 5 μm.

In order to tailor the PTFE:PDA ratio, two sets of coating compositions were prepared. The first set was comprised of 5 concentrations of PDA (dopamine hydrochloride) in deionized water, each mixed at a 1:2 ratio by weight with PTFE (60% (w/w) in aqueous solvent). For the second set, the concentration of PTFE was varied five times and mixed at a 2:1 ratio by weight with the best performance, PDA concentration (11.5% (w/w) in deionized water, from the first set. Samples were spray coated on PTFE composite film liners and cured in a THERMO SCIENTIFIC LINDBERG/BLUE M Moldatherm Box Furnace at 315° C. for 10 min, unless otherwise stated. The samples were laminated on metal substrates.

Coated/cured PTFE composite film liners were laminated on 1″×2″ 1006 carbon steel substrates using a Carver hydraulic press with both platens at 371° C., under an applied lamination force of 2,000 pounds, and lamination time of 10 min. Three samples per condition (10) were laminated. To evaluate the adhesion performance of the laminated samples, peel test experiments were conducted.

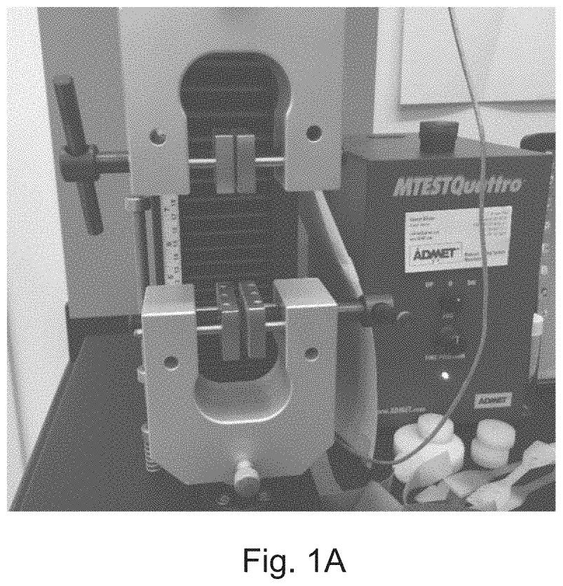

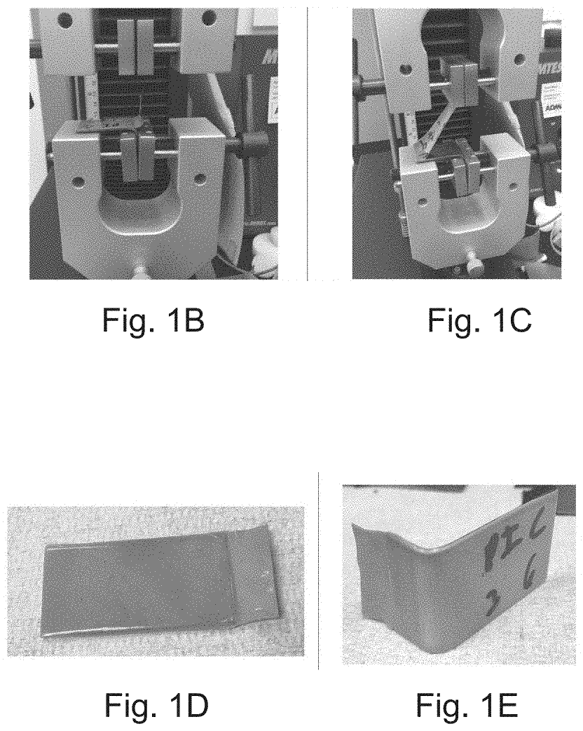

The performance of each sample was evaluated using a single column testing machine (MTESTQUATTRO) from ADMET (see FIG. 1a to FIG. 1c). The procedure used for the experiments was similar to the BS EN 28510-1:2014 standard test method. To perform the 90° peel test, the laminated samples were bent at a 90° angle using a small vise grip and a mallet. The peel length was reduced to 1.5″ since ½″ of the 1″×2″ laminated samples was bent to a 90° angle (see FIG. 1d and FIG. 1e).

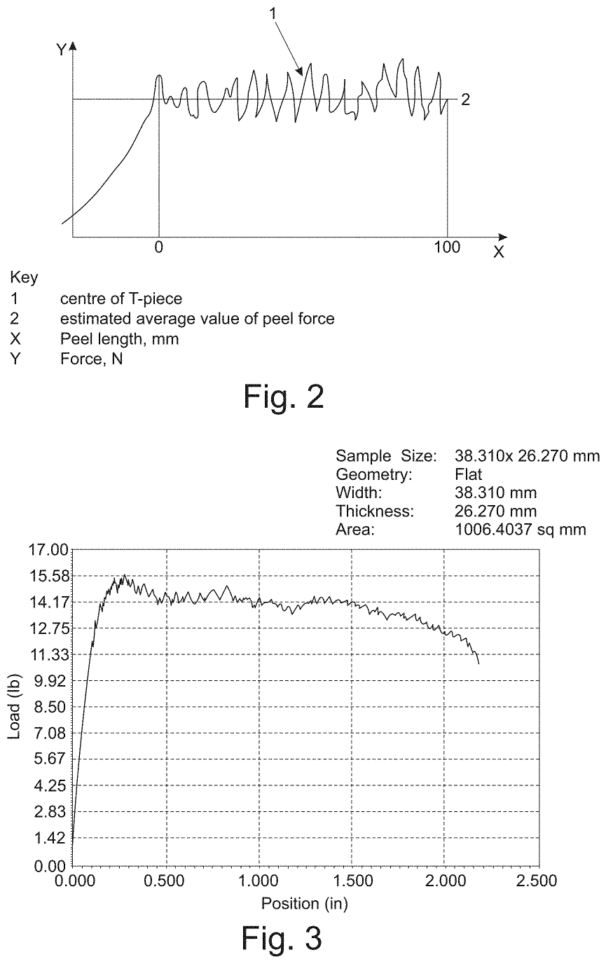

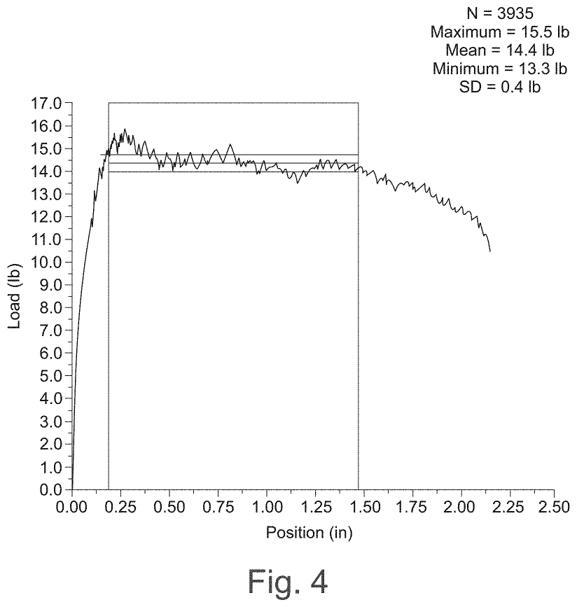

The average and maximum peel strength or pull force were extracted from each sample using ORIGINPRO 2018 from OriginLab Corporation (see FIG. 2, FIG. 3, and FIG. 4). For this report, only the maximum peel strength of each sample was used. The maximum peel strength of three samples was extracted and the average along with its standard deviation were reported (average±standard deviation, n=3) unless otherwise stated.

A surface stylus profilometer was used to measure the coating thickness of the samples. While the bulk of the examples was performed coating the liners to reach a surface coverage that corresponded to a mass of 0.006 g/in² on the surface, thicker coatings were also applied.

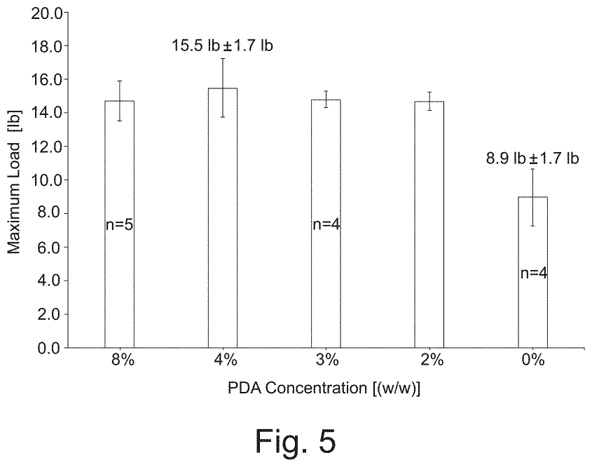

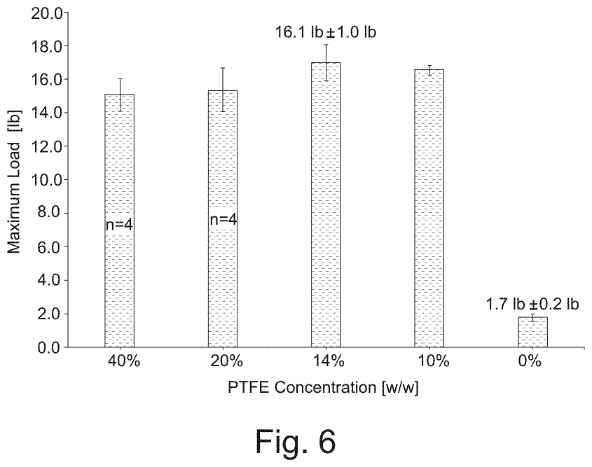

The performance of each condition was evaluated using a 90° peel test. The average of three different peel tests were reported. FIG. 5 shows the results of the first set of conditions evaluated using the maximum peel force or load of each sample. For this set (samples 11 to 14), the comparative example was 40% (w/w) PTFE (sample 15). The maximum load for the control was 8.9 lb±1.7 lb, n=4. This result indicates the contribution of PDA on the adhesion strength of the coating. The maximum load for was 15.5 lb±1.7 lb, n=3. This load was about 44% higher than sample 15. For the second set (samples 21 to 24), the comparative example was 4% (w/w) PDA (sample 25). The concentration of PTFE was varied five times keeping the PDA concentration constant. The measured maximum load for this condition was 16.1 lb±1.0 lb, n=3.

As compared to the comparative example (4% (w/w) PDA) (sample 25), this condition was about 89% higher. The maximum load for sample 25 was 1.7 lb±0.2 lb. Sample 23 was used for the rest of the experiments.

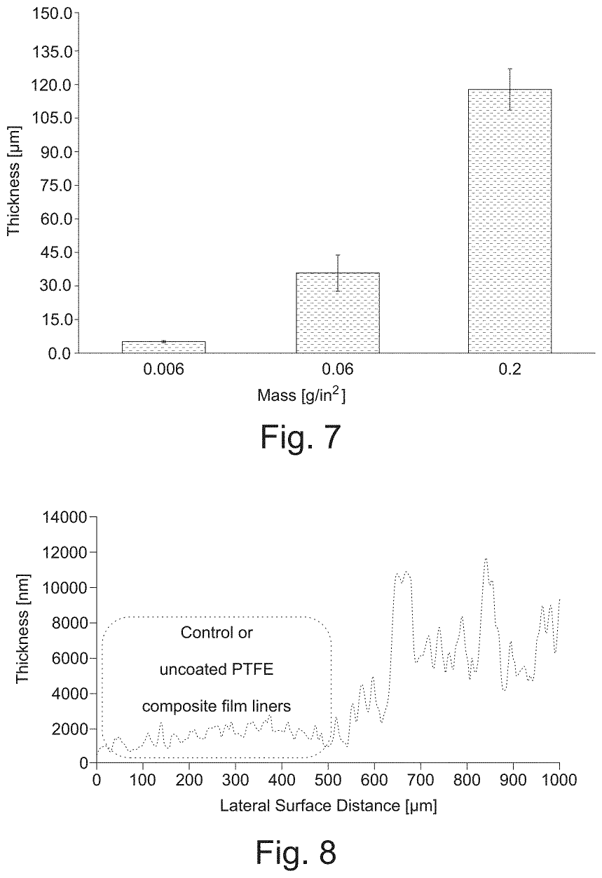

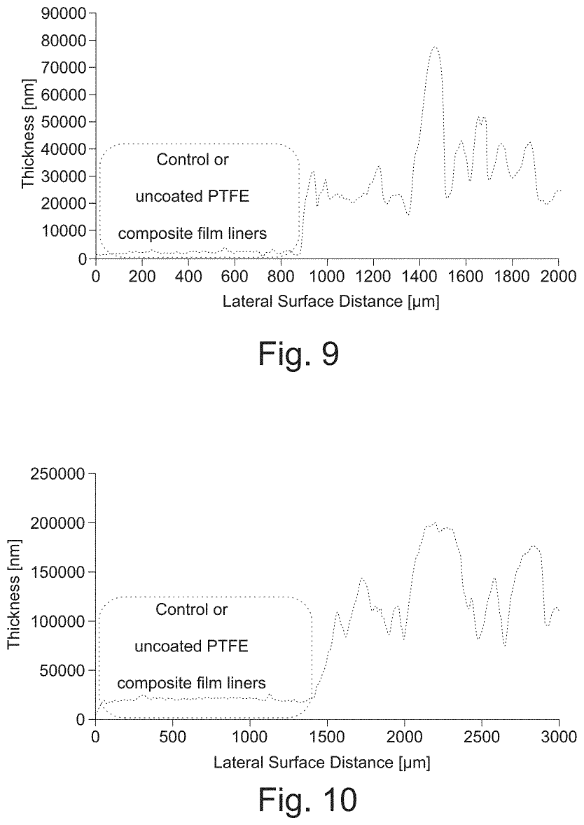

PTFE composite film liners were spray coated using the coating composition (sample 23). These liners were spray coated at three different thicknesses (5, 30, and 100 μm). The curing temperature and time used for the samples was 315° C. and 10 min. The coating thicknesses of each sample were measured using a profilometer. As surface profiles in FIG. 8, FIG. 9, and FIG. 10 illustrate, and FIG. 7 summarizes for all samples, the target coating mass of 0.006 g/in² of the coating composition on the surface yielded a coating thickness of 5.2±0.6 μm, while the higher masses of 0.06 and 0.2 g/in² correspond to coating thickness of 37.2±8.4 μm and 122.2±9.6 respectively. As it can be observed on the surface scans, the PTFE composite film liners on the left of the surface profiles have a much smoother overall surface texture, while the coatings on the right have a much rougher profile which is a characteristic of the spray deposition process.

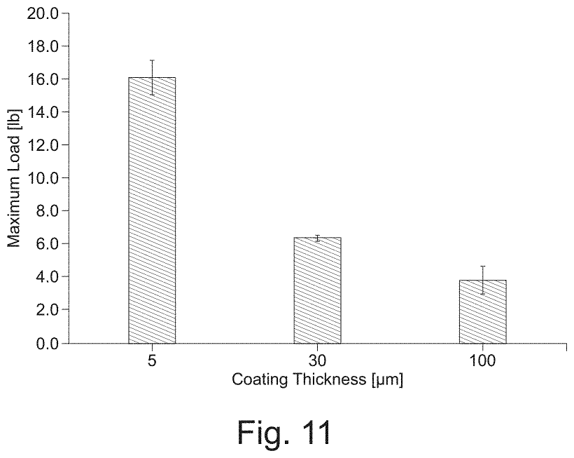

The coated/cured liners were laminated at a temperature of 371° C., under a lamination force of 2,000 pounds, and a lamination time of 10 min on 1″×2″ 1006 carbon steel substrates. All the samples tested for this report were laminated on 1″×2″ 1006 carbon steel substrates. After lamination, the maximum peel strength for each sample was measured using the 90° peel test. Three samples were peel tested for each thickness. FIG. 11 shows the results of the peel tests conducted on those samples.

As shown on FIG. 11, for the coating thickness of 5 μm, the maximum load for that coating thickness was 16.1 lb±1.0 lb. The adhesion strength of the coating decreases with increasing coating thickness. The maximum load for the laminated samples, made using coating thicknesses of 30 μm and 100 μm, were 6.4 lb±0.2 lb and 3.8±0.8 lb, respectively. For 5 μm of thickness, the curing temperature was evaluated.

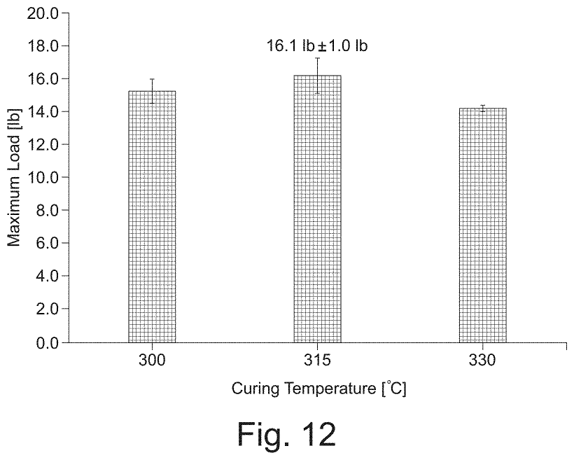

The curing (heating) temperatures tested were 300° C., 315° C., and 330° C. For these experiments, sample 23 having 5 μm of thickness were used. Peel test measurements were conducted on the laminated samples. FIG. 12 shows maximum load maximum load as a function of curing temperature. The maximum peel strength for the samples using 315° C. as curing temperate was 16.1 lb±1.0 lb. The lamination time for PTFE composite film liner was studied using sample prepared using 315° C. of heating temperature.

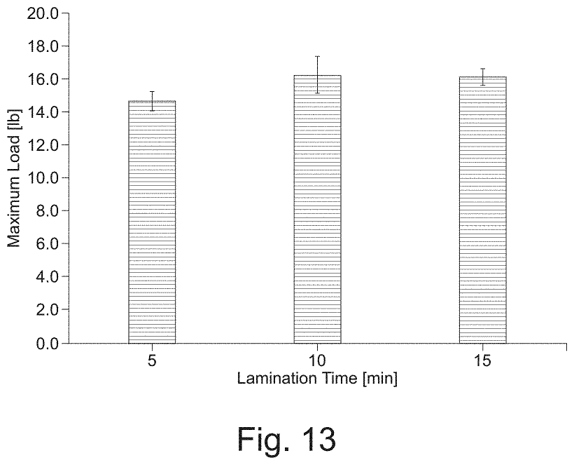

Three different lamination times were tested using the sample prepared using 315° C. of heating temperature (coating composition ratio, coating thickness, and curing temperature). Samples were laminated at 371° C. and under 2,000 pounds of force using Carver hydraulic press. The lamination times used for this set of experiments were 5, 10, and 15 min. The peel test results of the laminated samples are shown in FIG. 13. There was no significant difference between the lamination time of 10 and 15 min. Overall, the impact of the lamination time was not as pronounced as the coating thickness (FIG. 11). The maximum load values for the lamination times of 5, 10, and 15 min were lamination times were 14.8 lb±0.5 lb, 16.1 lb±1.0 lb, and 16.0 lb±0.5 lb respectively. The last parameter to be tested was the lamination force.

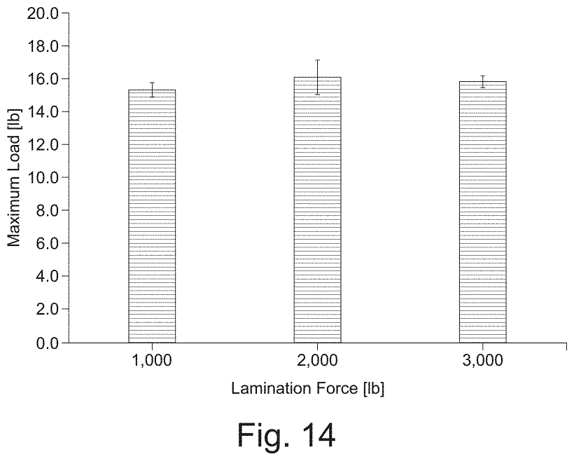

After evaluating different parameters on PTFE composite film liners, the lamination force was tested. Samples were laminated at 371° C., lamination time of 10 min, and under three different lamination forces on the Carver hydraulic press. Lamination forces of 1,000, 2,000, and 3,000 pounds were tested. Initially a lamination force of 4,000 pounds was tested, but after lamination the laminated PTFE composite film liner was damaged due to overheating caused by the increase in lamination force; thus 3,000 pounds of force was selected. FIG. 14 shows the results of this experiment. The maximum load for 2,000 pounds of the lamination force was 16.1 lb±1.0 lb, n=3. However, the difference between maximum load values of the samples laminated using different lamination forces was not significant.

The maximum load for the tested samples laminated under 1,000, 2,000, and 3,000 pounds were 15.4 lb±0.4 lb, 16.1 lb±1.0 lb, and 15.9 lb±0.4 lb, respectively for n=3. A final experiment was conducted adding copper nanoparticles to the same sample.

To determine whether adding nanoparticles to the coating composition improves adhesion or not, copper nanoparticles were added to the PTFE/PDA coating solution. A coating composition having PTFE, PDA, and copper nanoparticles of 70 nm was prepared. These chemicals were mixed at a ratio by weight of 2:1:1 PTFE:PDA:copper. The coating composition was sprayed on PTFE composite film liners at a thickness of about 5 μm. The coated liner was cured at 315° C. for 10 min and laminated on 1″×2″ 1006 carbon steel substrates under the lamination conditions of 2,000 pound and 10 min. The laminated samples were tested using a 90° peel tester. The measured maximum load for the samples laminated using coated PTFE composite film liner, having copper nanoparticles was 10.5 lb±1.3 lb, n=3. Adding copper nanoparticles to the coating composition impacts negatively on the adhesion. Laminated samples coated using the coating composition yielded a maximum load of 16.1 lb±1.0 lb, n=3, vs. laminated samples coating using the coating composition (sample 23) plus copper nanoparticles that yielded a lower maximum load of 10.5 lb±1.3 lb, n=3. Compared to the comparative example (sample 15; pure PTFE), adding copper nanoparticles did not make any significant difference on the adhesion strength. The maximum load for the laminated samples using pure PTFE was 8.9 lb±1.7 lb, n=4. For adhesion application, copper nanoparticles are detrimental to the adhesion strength.

Anti-Corrosion Agent Examples

Coating for Use as Anti-Corrosion Agents

The examples were performed regarding the PTFE:PDA ratio, coating thickness, and curing temperature of the coating composition. Finally, a coating composed of PDA:PTFE, PDA:PTFE:graphite, and PDA:Cu nanoparticles was deposited on carbon steel and aluminum in 24 hour salt spray corrosion testing.

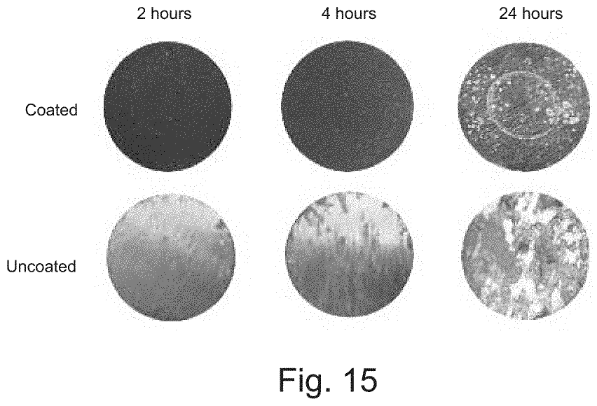

The present invention provides a corrosion resistant coating that can be readily applied to a wide array of metallic substrates (aluminum, magnesium, carbon-steel, stainless-steel, as well as anodized/alanine metals). The coating offers a thin light weight permanent coating that requires no replenishing and is designed to allow sufficient corrosion protection necessary to last numerous overhaul cycles. The present invention's coating is also chemically inert, and thus can withstand exposure to harsh chemical conditions (highly acidic and basic conditions) and aggressive chemical cleaning procedures. The coating yields a robust protective coating that can extend the lifecycle of highly complex and costly parts. The salt spray results (0.1 M NaCl at 35 C) illustrate the difference in corrosion for coated and uncoated substrates FIG. 15. Tribologically, the coating of the present invention offers a wear life greater than any other state of the art fluorocarbon coating FIG. 15.

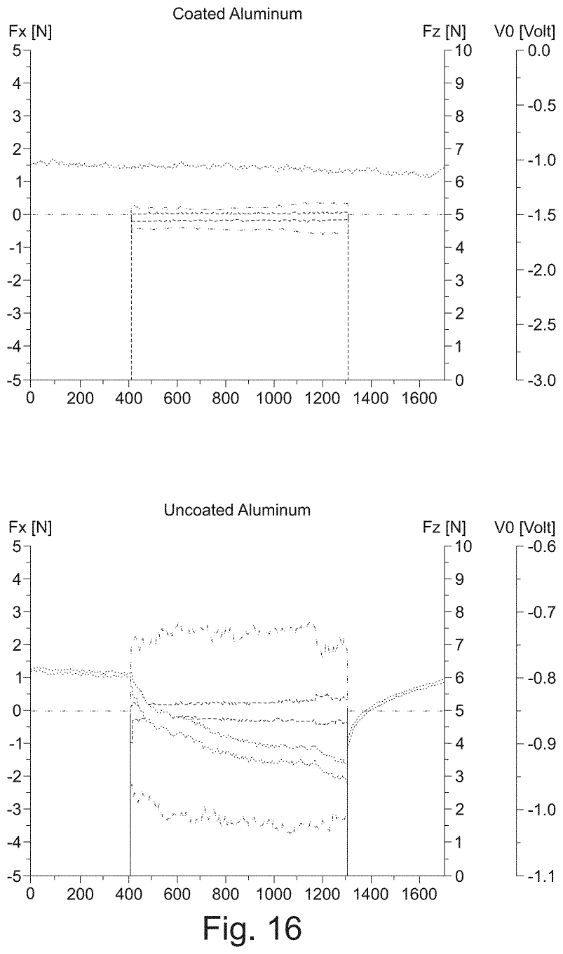

Tribo-corrosion tests demonstrate will corrode at a fast rate as the surface is abraded. The coating of the present invention provides wear resistance and resistance to chemical attack, which makes it an excellent candidate for an application where the anticorrosion protective coating is exposed to high load/high velocity dynamic contact. See for example Tribo-corrosion results (0.1 M NaCl at 25 C) demonstrating corrosion with regards to wear for coated and uncoated steel substrates FIG. 16.

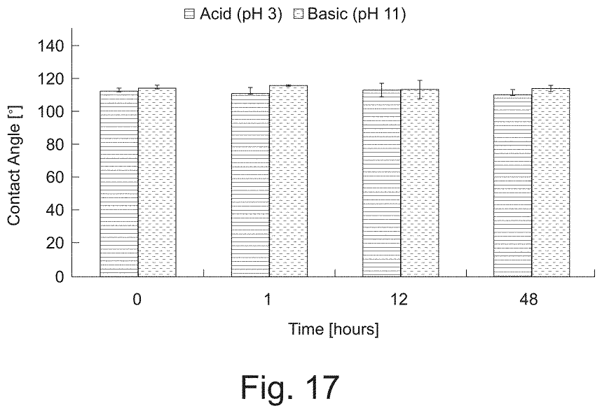

Water contact angle measurements reveal that the coating of the present invention has a low surface energy that makes it unreactive and resistant to chemical attack. The surface energy is maintained in acidic and basic environments allowing the coating to remain unreactive and maintain its anticorrosion properties in both extremes. See for example FIG. 17, providing the contact angle measurements with respect to time illustrating the effect of immersion in acidic and basic conditions have on coated substrates of the present invention.

Anti-Radar Agent Examples

Coatings for Use as Anti-Radar Agents

The examples were performed regarding the PTFE:PDA ratio, coating thickness, and curing temperature of the coating composition. A coating composed of PTFE and PDA was deposited on carbon steel and aluminum.

Three solutions were prepared. Firstly, 4 grams of dopamine hydrochloride was dissolved in 16 grams deionized water. Next, a solution, of 4 grams of quartz particle was dissolved in 16 grams deionized water. The quartz solution and 105 grams of poly tetrafluoroethylene solution (DISP30) was mixed for 5 min. Then, immediately before spraying, the quartz and PTFE mixture was mixed with the dopamine solution by magnetic stirring for 5 minutes until a homogenous mixture was obtained.

Aluminum substrate with the surface area of 6×6 in² or 12×12 in² was cut. The substrates were ultrasonically cleaned for 5 minutes in 1% liquidnox, deionized water, acetone, deionized water, isopropanol and deionized water, respectively. Afterward ultrasonically cleaned substrates were air dried.

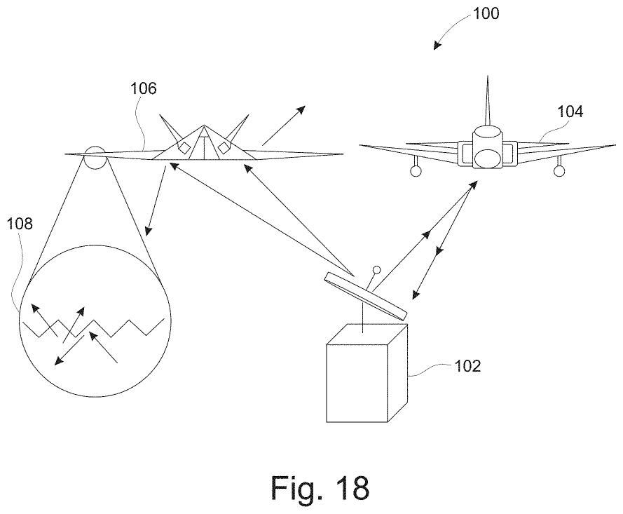

Anti-radar surfaces were fabricated using a facile one-step process through spraying the polymer/particle mixture onto substrates. The prepared solution was fed into the pressure vessel immediately after preparation (to avoid polymerization of dopamine). The deposition conditions employed are summarized in Table 1. The coating solution was sprayed onto the aluminum substrates using high-volume low-pressure air atomization automatic spray gun (HVLP). After spraying multi layers of coating material the coated surface was dried using a blower. A predetermined amount of coating material was sprayed to produce a specific coating mass (1-2 gram/in²), dried samples were pre-cured for 15 minutes on a hotplate at the 120 QC then the sample was fully cured using a Thermo Scientific Lindberg/Blue MT™ Moldatherm Box Furnace (at the temperature of 380 QC for 10 minutes). FIG. 22 shows the images of the coated sample. The schematic of anti-radar mechanism 100, anti-radar aircraft 106, nanostructure surface 108, radar device 102, and normal aircraft 104 is illustrated in FIG. 18.

TABLE 1
Deposition conditions

| Parameter | Range | |
|---|---|---|
| Air pressure | 40 | psi |
| Fluid flow | 20-35 | |
| Vessel pressure | 5-10 | psi |
| Final coating mass | 1-2 | gram/in² |
| Distance between airbrush | 11 | in |
| and substrates | | |

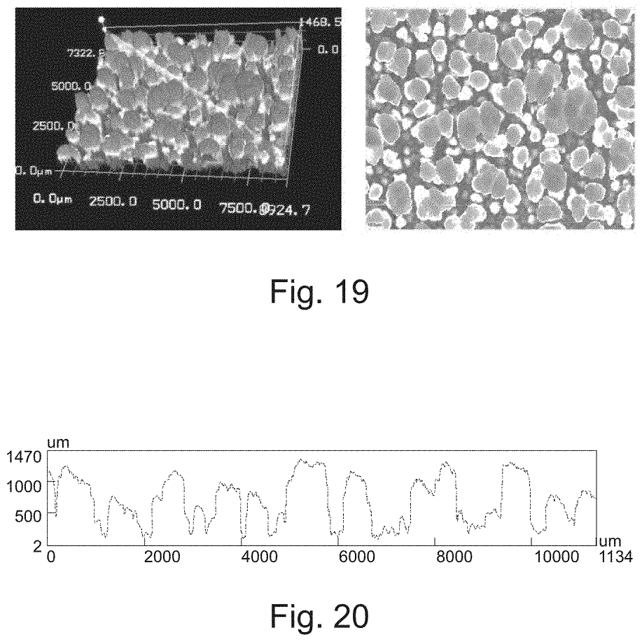

3D laser microscope was used to assess the roughness of the coated sample. The 2D and 3D image of the coated sample is demonstrated in FIG. 19. The roughness profile of the coated sample with Ra=500 nm is shown in FIG. 20.

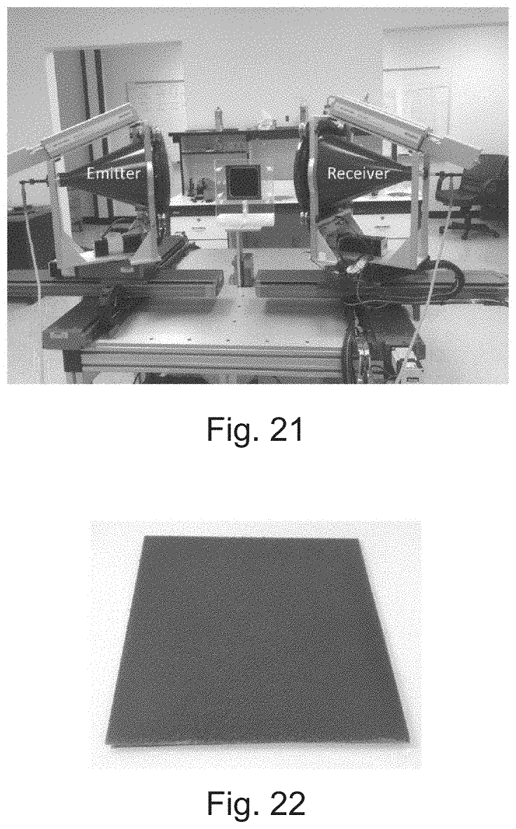

To evaluate anti-radar behavior of coated samples, bistatic measurements at different angles for coated and uncoated samples was done. The system arrangement for bistatic measurements is shown in FIG. 21. The bistatic measurement is 55 degrees for two different anti-radar coatings of the present invention versus the uncoated substrate.

Ice-Phobic/Anti-Ice Agent Examples

Coatings for Use as Ice-Phobic/Anti-Ice Agents

The examples were performed regarding the PTFE:PDA ratio, coating thickness, and curing temperature of the coating composition. A coating composed of PTFE and PDA was deposited on aluminum substrates.

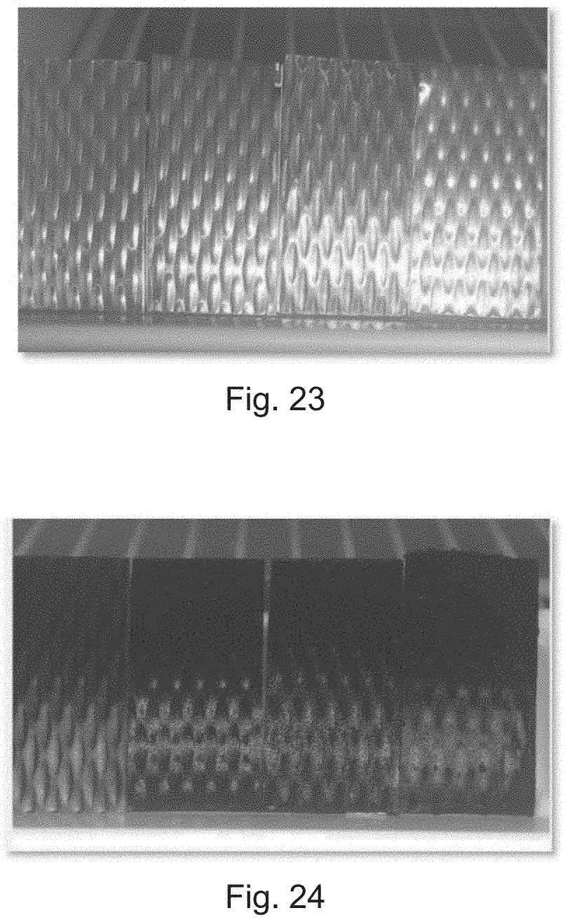

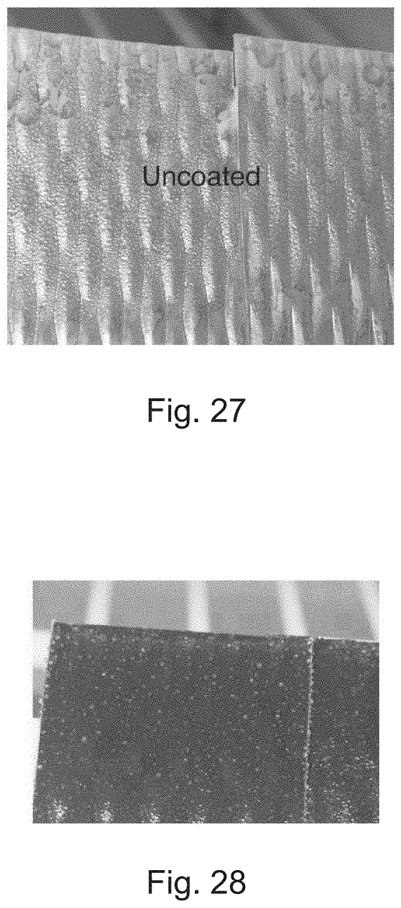

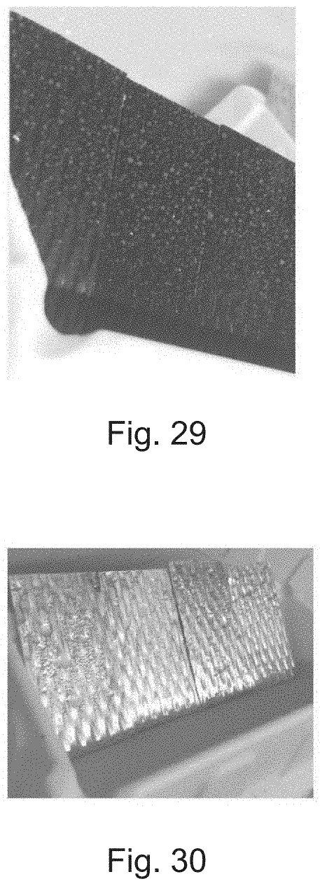

Over a period of 2 weeks in order to observe frost accretion, 4 samples of uncoated embossed FIG. 23 aluminum and 4 samples of coated embossed aluminum FIG. 24 were placed in a freezer with an average temperature of −18 C. For the first week of the study, morning, mid-day and evening the freezer door was left open for 5 minutes to the ambient environment of 60% humidity and room temperature. After the first week results were inconclusive because frost did not fully form on the coated substrate FIG. 26. In the second week, more ambient humidity was increased to 70-75% with a steam humidifier positioned near the opened door FIG. 27 and FIG. 28. After the course of the 2 weeks the frost that formed on the coated samples were in spherical shapes being in the Cassie-Baxter solid state of contact FIG. 29. This minimal surface contact requires less energy to remove. The uncoated sample ice had higher contact with the surface as a glaze ice FIG. 30. Glaze ice is difficult to remove.

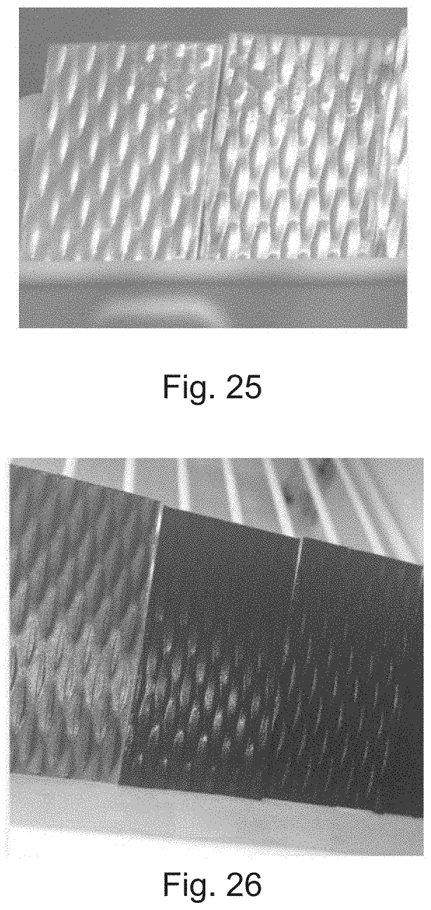

After the first 5 days, it could be observed that the uncoated aluminum samples had larger glaze ice frost formed on the surface FIG. 25. Glaze ice indicates the solid water has larger contact surface with the substrate.

On the coated substrate, minimal amounts of difficult to see frost would appear but then quickly disappear after the door was opened and then closed.

After 9 days of observation the uncoated sample had significant glaze ice on the surface FIG. 27. Whereas the coated sample had ice form in spheres, which indicates the ice that formed had low attachment to the surface, remaining in a Cassie-Baxter solid ice state FIG. 28.

At the end of the study, it was concluded the coated samples had Cassie-Baxter spherical shaped ice formed on the surface whereas the uncoated aluminum had difficult to remove glaze ice formed.

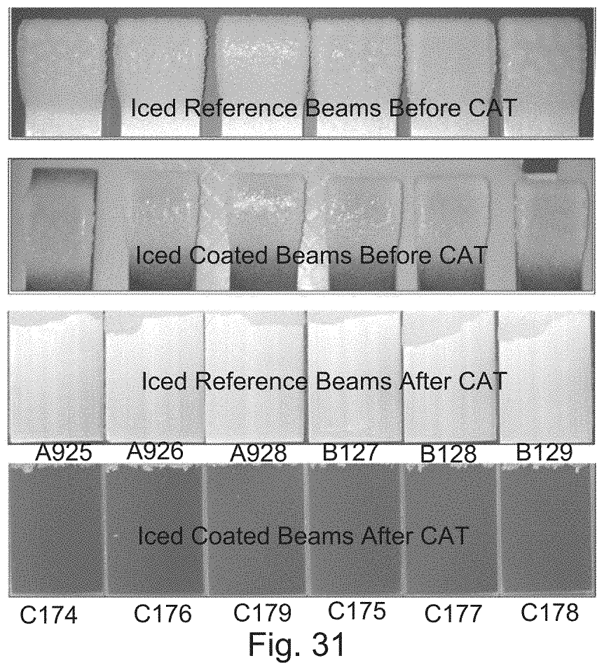

In further testing, a centrifuge ice adhesion (CAT) test performed at AMIL International Laboratory revealed that the coating of the present invention exhibits an adhesion reduction factor of 3.3. FIG. 31.

Spectroscopic Characterization of Coated Substrate Examples

The dopamine polymerization mechanism involves the oxidation of catechol in dopamine to quinone. Here 4 different methods were used to coat stainless-steel by polydopamine. The N/C molar ratio for PDA layers ranged from 0.05 to 0.07 (Table 2) which are below the theoretical value of pure dopamine. There is a thin layer of polydopamine on stainless-steel substrates and XPS (X-ray Photoelectron Spectroscopy) can detect underlayer signals as well. However, the result showed that the nitrogen content increased from 0% to 5.5 after a dopamine coating on the surface.

TABLE 2
Survey wide scan XPS spectrum measurement results

| Samples | C | O | N | N/C |
|---|---|---|---|---|
| Dopamine Theoretical value | 70 | 20 | 10 | 0.129 |
| Control (Stainless steel) | 46.9 | 26.7 | 0 | 0 |
| PDA (Tris•HCl method) | 80.2 | 14.3 | 4.4 | 0.05 |
| PDA (using Oxidizer) | 82 | 12.5 | 4.4 | 0.05 |
| PDA (spray coated and cured) | 77.6 | 14.5 | 5.3 | 0.068 |
| PDA (spray coated without curing) | 70.9 | 21.4 | 5.5 | 0.077 |

When dopamine polymerizes to polydopamine, catechol can easily oxidize to quinone and form cross-linking. This is attributed to a reverse dismutation reaction between the o-quinone and catechol form of dopamine molecules. By deconvolution of the C1s core level, three peaks were assigned to CN/C—O, C═O/COOH and —CH—. In the comparison between all 4 methods of coating the surface using dopamine, it can be seen in the case of spraying dopamine on the surface without subsequent curing (c) there is no evidence of C═O. The percentage of C═O increased for all other deposition methods, including spray coating with subsequent curing, which shows formation of quinone functional groups. Moreover, the N1s high resolution spectrum indicated two peaks for the polydopamine layer, R—NH2 and R—NH—R, and R—NH2 for dopamine molecules. The proposed polydopamine structure show that both NH2 and NH groups are present in polydopamine, whereas dopamine alone has NH2 groups.

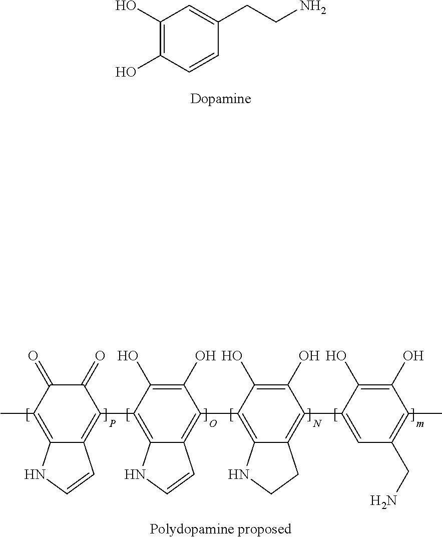

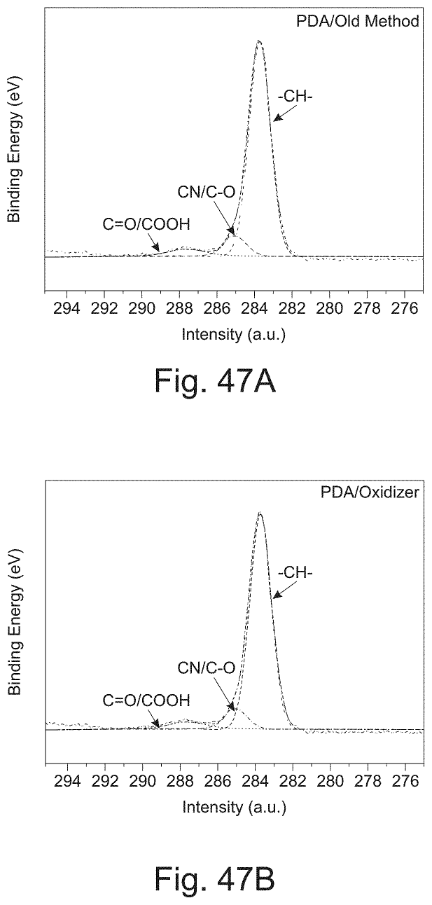

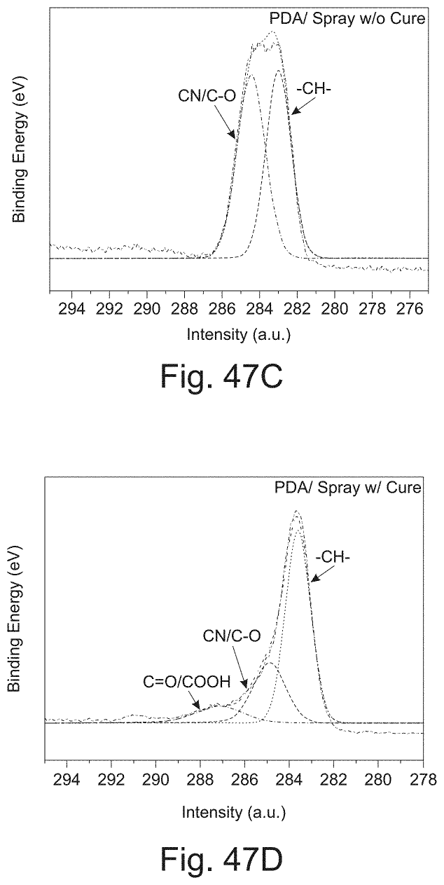

Therefore, the results show that for all three deposition methods: a) dip coating tris.HCL, b) polymerization of dopamine+oxidizer, and c) spray coating dopamine with subsequent curing at 315° C., dopamine successfully polymerized to polydopamine. FIG. 47A-47D.

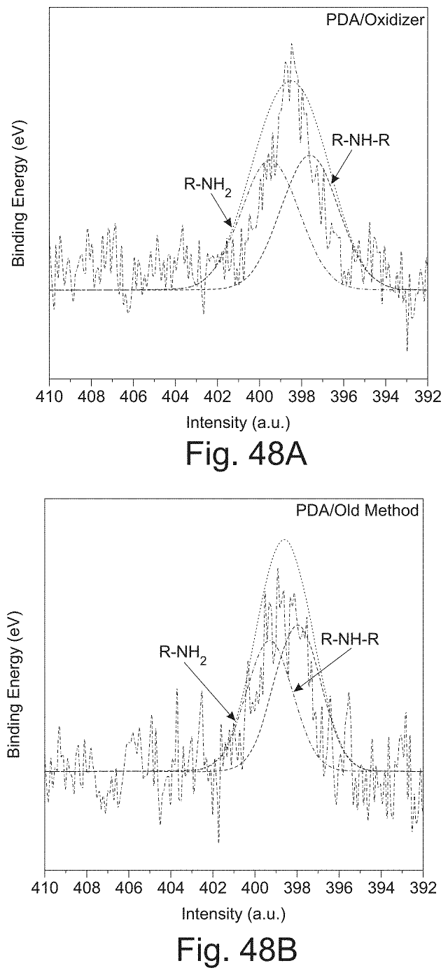

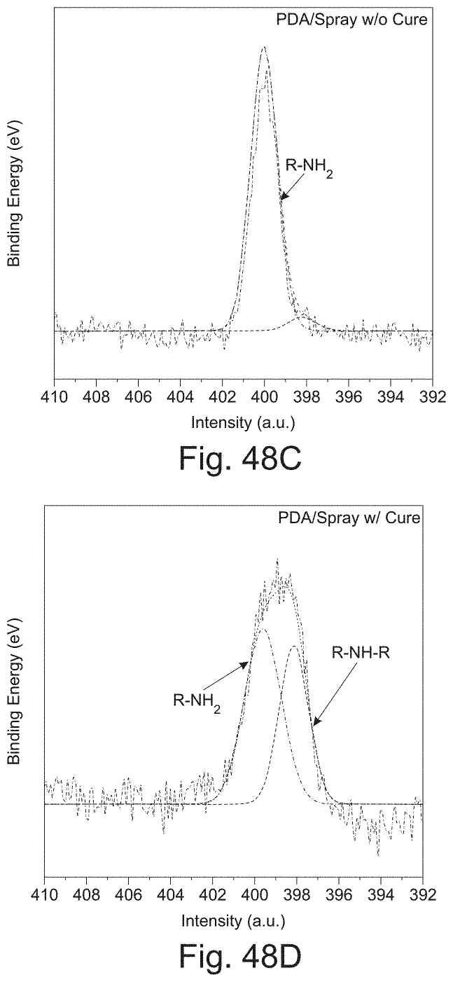

After making sure dopamine can successfully polymerize onto the surface using spray coating with curing at 315° C. FIG. 47A-47D, PTFE/dopamine with different fillers was sprayed onto the stainless-steel substrate and cured at 315° C. FIG. 48A-48D. The XPS result illustrated in Table 3 shows dopamine and fillers cannot be distinguished using XPS and it can be attributed to low concentration <3% (w/w dopamine/PTFE) of dopamine.

TABLE 3
PTFE/dopamine with different fillers was sprayed onto
the stainless-steel substrate and was cured at 315° C.

| Samples | F1s | C1s | N1s | O1s |
|---|---|---|---|---|
| Stainless steel | 2.6 | 46.4 | 3 | 37.9 |
| PDA/PTFE | 67.1 | 32.9 | 0 | 0 |
| PDA/PTFE/Quartz | 66.7 | 33.3 | 0 | 0 |
| PDA/PTFE/Silica | 57.4 | 42.4 | 0.1 | <0.1 |
| PDA/PTFE/Copper | 67 | 33 | 0 | 0 |

### REFERENCES

1. Ou, J.; Liu, L.; Wang, J.; Wang, F.; Xue, M.; Li, W. Fabrication and Tribological Investigation of a Novel Hydrophobic Polydopamine/Graphene Oxide Multilayer Film. Tribology Letter Journal. Vol. 48, Issue 3. pps 407-415 (2012.).
2. Ou, J.; Wang, J.; Qiu, Y.; Lanzhong, L.; Yanga, S. Mechanical Property And Corrosion Resistance Of Zirconia/Polydopamine Nanocomposite Multilayer Films Fabricated via A Novel Non-Electrostatic Layer-By-Layer Assembly Technique. Surface and Interface Analysis Journal. Vol. 43. Issue 4 pps. 803-808 (2011).
3. Lee, H. Bioadhesion of Mussels and Geckos: Molecular Mechanics, Surface Chemistry, and Nanoadhesives. (2008).

1. A coating composition comprising:
a fluoropolymer and a dopamine derivative.

2. A process for fabricating a coated a substrate, the process comprising the steps of:
(a) providing a mixed coating composition comprising a fluoropolymer, a dopamine derivative and a solvent;
(b) locating the coating composition onto a substrate; and
(c) heating and curing the coating composition to remove the solvent.

3. The process of claim 2, wherein the fluoropolymer to the dopamine derivative in the composition has a weight ratio of from 1.0 to 50.

4. (canceled)

5. (canceled)

6. (canceled)

7. The process of claim 2, wherein the solvent is an aqueous liquid.

8. The process of claim 2, wherein the solvent is water.

9. The process of claim 2, wherein the solvent is isopropanol, ethanol, or methanol.

10. The process of claim 2, wherein the solvent is combined with one or more components selected from the group consisting of n-butyl acetate, n-heptane, ethylene glycol monoethyl ether, ethyl acetate, and methyl ethyl ketone.

11. The process of claim 2, wherein the coating composition further comprises a filler.

12. The process of claim 11, wherein the coating composition further comprises a nanoparticle filler.

13. The process of claim 12, wherein the nanoparticle filler is selected from one or more members of the group consisting alumina, graphite, silica, quartz, sepiolite, capstone, and copper nanoparticles.

14. The process of claim 2, wherein the coating composition further comprises a surfactant.

15. The process of claim 2, wherein the dopamine derivative has a concentration of between 1.0 weight % to 20.0 weight %.

16. (canceled)

17. (canceled)

18. (canceled)

19. The process of claim 2, wherein locating the coating composition further comprises dipping, spraying, spinning, or roll coating, or any combination thereof.

20. The process of claim 2, wherein heating is at a temperature of between 250° C. to 400° C.

21. The process of claim 2, wherein the process further comprises pressing the heated and coated substrate surface against another material surface to provide a lamination.

22. The process of claim 2, wherein the coated substrate is anti-corrosive, anti-radar, or ice-phobic.

23. (canceled)

24. (canceled)

25. The coating composition of claim 1, further comprising copper nanoparticles, graphite nanoparticles, silica nanoparticles, or alumina nanoparticles.

26. (canceled)

27. (canceled)

28. (canceled)

29. An ice-phobic coating composition prepared by a process comprising the steps of:
mixing a fluoropolymer, a dopamine derivative, a solvent and filler.

30. The process of claim 29, wherein the filler is one or more nanoparticle components selected from the group consisting of alumina, graphite, silica, quartz, sepiolite, capstone, and copper.

31. (canceled)

32. (canceled)

33. (canceled)

34. (canceled)

35. The composition of claim 1, further characterized by the XPS pattern shown in FIG. 47A, FIG. 47B, FIG. 47C, FIG. 47D, FIG. 48A, FIG. 48B, FIG. 48C, or FIG. 48D.

36. (canceled)

37. The process of claim 2, further comprising pressing to densify and reduce porosity before, after, or during heating and curing the coating composition to remove the solvent.
